(19) United States
(12) Patent Application Publication
(10) Pub. No.: US 2025/0252040 A1
(43) Pub. Date: Aug. 7, 2025

(54) METHODS AND APPARATUS TO EXECUTE MEMORY ACCESS FORMULAS IN MEMORY CHIPLETS

(71) Applicant: Openchip & Software Technologies S.L., Barcelona (ES)

(72) Inventors: Francesc Guim Bernat, Barcelona (ES); Tommaso Vali, Sezze (IT); Erich Ludwig Focht, Stuttgart (DE); Satoru Tagaya, Barcelona (ES); Violante Moschiano, Avezzano (IT); Gaspar Mora Porta, Castellon de la Plana (ES)

(21) Appl. No.: 19/186,293

(22) Filed: Apr. 22, 2025

Related U.S. Application Data
(63) Continuation of application No. PCT/EP2025/054494, filed on Feb. 19, 2025.

(51) Int. Cl. G06F 12/02

(52) U.S. Cl. CPC G06F 12/0223

(57) ABSTRACT

Systems, apparatus, articles of manufacture, and methods are disclosed for executing memory access formulas in memory chiplets. An example system includes a plurality of memory chiplets including a first memory chiplet and a second memory chiplet. In the example system, the first memory chiplet is to register a formula with an identifier in a formula data structure. In the example system, the first memory chiplet is also to determine, based on the formula data structure, that the second memory chiplet stores data corresponding to the formula. The example system also includes interconnect chiplet circuitry connected to the plurality of memory chiplets, the interconnect chiplet circuitry to communicate a request from the first memory chiplet to the second memory chiplet to obtain the data corresponding to the formula.

### RELATED APPLICATION(S)

This patent arises from a continuation of International Patent Application No. PCT/EP2025/054494, which was filed on Feb. 19, 2025. Priority to International Patent Application No. PCT/EP2025/054494 is claimed. International Patent Application No. PCT/EP2025/054494 is incorporated herein by reference in its entirety.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to memory accesses and, more particularly, to methods and apparatus to execute memory access formulas in memory chiplets.

### BACKGROUND

Sparse matrices are matrices in which most elements are zero rather than non-zero. Sparse matrix multiplication (SpMM) is a workload that involves multiplying a tensor (e.g., a dense vector, a sparse matrix, an array, etc.) and a sparse matrix to generate some product. Sparse matrix multiplication is a fundamental linear algebra operation and a building block for more complex algorithms. Sparse matrix multiplication is also an important kernel used in many domains such as fluid dynamics, deep learning, graph analytics, economic modeling, etc. In the context of deep learning, sparsity is an important approach for improving training and inference performance as well as reducing the model sizes while maintaining model accuracy.

### BRIEF DESCRIPTION OF THE DRAWINGS

FIG. 1 is a block diagram of an example computing environment in which an example in-memory compute circuitry operates to perform in-memory operations based on instructions from an example core and an example software stack.

FIG. 2 is a block diagram of an example implementation of the in-memory compute circuitry of FIG. 1.

FIG. 3 is a flowchart representative of example machine readable instructions and/or example operations that may be executed, instantiated, and/or performed by example programmable circuitry to implement the in-memory compute circuitry of FIG. 2.

FIG. 4 is a flowchart representative of example machine readable instructions and/or example operations that may be executed, instantiated, and/or performed by example programmable circuitry to implement in-memory compute circuitry of FIG. 2 to register a formula with one or more memory chiplets.

FIG. 5 is a flowchart representative of example machine readable instructions and/or example operations that may be executed, instantiated, and/or performed by example programmable circuitry to implement in-memory compute circuitry of FIG. 2 to execute a formula at a memory chiplet.

FIG. 6 is a flowchart representative of example machine readable instructions and/or example operations that may be executed, instantiated, and/or performed by example programmable circuitry to implement in-memory compute circuitry of FIG. 2 to address a memory coherency requirement.

FIGS. 7-10 illustrate further example systems that include the in-memory compute circuitry of FIGS. 1 and 2 to implement memory access operations in accordance with teachings of this disclosure.

FIG. 11 is a block diagram of an example processing platform including programmable circuitry structured to execute, instantiate, and/or perform the example machine readable instructions and/or perform the example operations of FIGS. 3-6 to implement the in-memory compute circuitry of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 3-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 15 illustrates an example hardware arrangement of an example data center.

FIG. 16A illustrates an example arrangement of an example chip assembly of FIG. 15.

FIG. 16B illustrates an example arrangement of an example chip assembly of FIG. 15, adapted for high-performance computing applications.

In general, the same reference numbers will be used throughout the drawing(s) and accompanying written description to refer to the same or like parts. The figures are not necessarily to scale.

### DETAILED DESCRIPTION

In general, sparse matrix multiplication (SpMM) performance is limited by memory bandwidth. A challenge with SpMM is that using standard representations and approaches can lead to ineffective compute and memory storage representations. For example, SpMM algorithms are defined based on storage formats such as a block sparse format. Each of these formats has its own granularity, which impacts performance of the multiplication operation. For example, block sparse format is a method for storing sparse matrices where, instead of storing individual non-zero elements, the format stores the non-zero elements in blocks of values with a row-based structure. Block sparse format impacts performance of the multiplication workload because memory accesses of the non-zero elements may be reduced due to the nature of the data structure in memory. As such, a primary distinction among sparse matrix representations is the sparsity pattern, or the structure of the non-zero entries in memory, for which they are suited.

However, at least some types of sparse representations sustain low percentages of machine peak performance due to their inherent poor cache usage and memory bound nature. For example, at least some types of sparse representations have an imbalance between memory bytes and floating point operations per second. As such, while memory bandwidth stays fully saturated during a matrix multiplication operation, compute utilization is low. Some proposed designs (e.g., proposed sparse representations) attempt to reduce compute bandwidth for those operations. Such proposed designs include using memory addresses that represent positions of memory where non-zero values are stored, also referred to as indirection.

Memory indirection is a technique in computer programming in which a memory address is used to access another memory location, rather than directly accessing the target data. For example, in an array [0 1 2 3 4] used for memory indirection, each array element stores a reference (or pointer) to the next element. This reference acts as an intermediary, an indirection. Therefore, to access the third element (2) in the array, a processor starts at the first element (0), follow its reference to the second element (1), and then follows that reference to the third element.

Implementing memory indirection may cause imbalance between the memory accesses and floating point operations per second (FLOPs). When using a sparse matrix representation and indirection, situations may arise in which the balance between the compute and memory access is limited by the amount of indirections needed to access the correct memory address in order to perform the computation. For example in a formula where a=x[y[x[b]]]*2, the processor performs three memory accesses (e.g., reads three elements from memory) for performance of just one computation. Therefore, there is a 3:1 ratio of memory read to memory write as well as a 3:1 ratio of memory read to compute.

Imbalance between memory access and computations results in poor computing performance (e.g., higher latency and bottleneck in bandwidth). For example, consider a computer with a processor that operates at 800 MHz that is connected to a memory through a 100 MHz bus. This processor manipulates 800 million items (e.g., instructions and/or data) per second and the memory achieves a debit (e.g., sending or receiving) of 100 million items per second. In this example, for each single memory access, 8 processor clock cycles have elapsed. As a result, 7 clock cycles in each group of 8 clock cycles are wasted waiting for items. That represents a high cost in latency and eventually bandwidth.

In some examples, to overcome the imbalance in the computer architecture (e.g., in computation and memory accesses), memory accesses and some computations are performed in a memory module (e.g., memory chiplet) using memory compute. For example, memory modules such as a Dual In-line Memory Module (DIMM) may be equipped with processor circuitry (e.g., in-memory compute technologies) to perform memory accesses and a set of one or more supported computations, rather than a core performing the memory accesses and those computations. By performing memory accesses and some computations at the memory module, fewer memory cycles are used to move data between memory and core and, thus, imbalance and latency are improved. However, performing all the memory accesses at the memory module may lead to other complexities.

For example, the memory management at the core uses virtual addresses to instruct the memory module (e.g., memory chiplet) as to what address data is stored in, but the memory management software may not know the physical mapping of the virtual address. And in some examples, data is distributed across different memory modules (e.g., memory chiplets) and, thus, one memory module may not have direct access to some of the data, and is limited to returning the particular data accessible by the memory module. For example, consider a computer architecture including a core, a software stack, a memory controller, and four memory chiplets. Also, in this example, assume the software stack is to compute a formula a=x[i]+x[y[i−1]], and directs one of the memory chiplets to access x[i], y[i−1], and x[y[i−1]] based on the virtual memory address. In the formula above, x and y are vectors or matrices, i is a base index value of vector x and vector y, and 1 is an offset of the index value. Furthermore, assume x[i] is located in the one memory chiplet, whereas y[i−1] and x[y[i−1]] are each located in two different memory chiplets. Using existing memory compute schemes, only x[i] may be returned to the core. Such memory management and memory compute schemes may not work if the data is spread across different memory chiplets, as in this example.

Example solutions disclosed herein support memory access operations, applicable in processor architectures such as chiplet-based processors, System-on-chip (SoC) circuitry, System-in-Package (SiP) or System-on-Package (SoP) circuitry, and/or any other modular packaging implementations of processor circuitry, that overcome at least some of the foregoing deficiencies of prior approaches and provide improvements to execute memory access formulas in memory chiplets. Examples disclosed herein improve overall computing performance of a computing system using in-memory computing based on chiplet-based architectures. For example, examples disclosed herein connect memory chiplets through an interconnect chiplet. An interconnect chiplet provides an interface to memory chiplets, allowing different memory chiplets to directly communicate with each other without routing the communication through a core (e.g., central processing unit (CPU)). Examples disclosed herein also improve in-memory computing performance based on efficient memory management techniques. For example, examples disclosed herein register a formula at one or more memory chiplets in a formula data structure, which provides the memory chiplet(s) with information related to physical memory addresses associated with the formula. This way, when a software stack provides a memory chiplet with a formula to be computed, the memory chiplet can identify where data of the formula is located, and request data from one or more remote memory chiplets using the interconnect chiplet. A s used herein, “registering” a formula is offloading, enrolling, and/or associating a formula from the core 104 to/with the memory chiplets. Such registering, offloading, and/or associating a formula with the memory chiplets configures (e.g., prepares, enables, etc.) the memory chiplets to execute the formula.

By facilitating in-memory computing in situations in which data is distributed across a plurality of memory chiplets, imbalance between memory access and compute operations is improved. For example, fewer cycles are used by the core to access data from memory and, thus, latency and bandwidth are improved. Examples disclosed herein improve the efficiency of using a computer by balancing the computer architecture and increasing the speed at which workloads, such as sparse matrix multiplication, are performed.

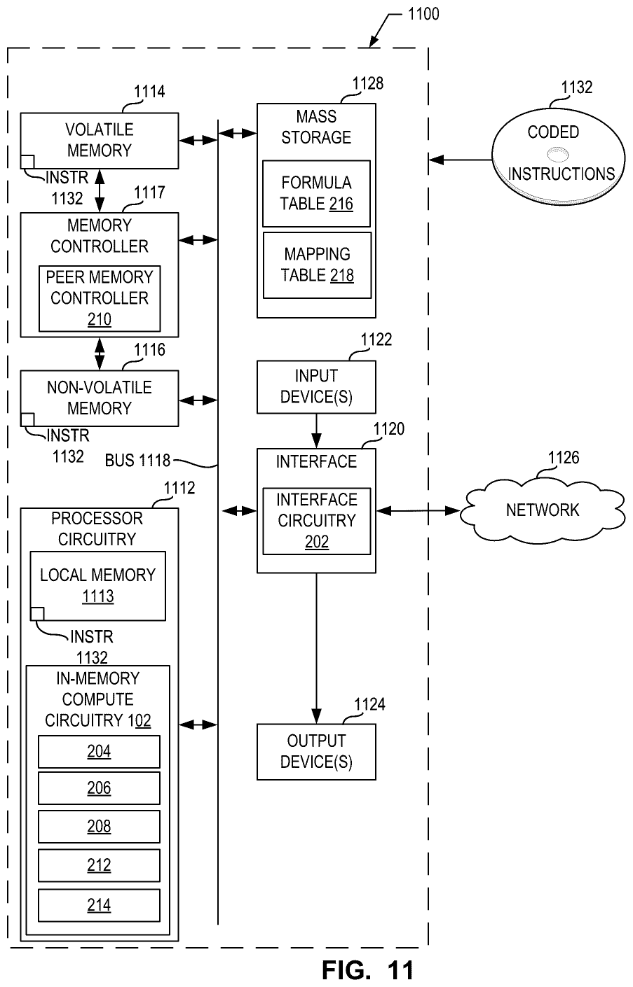

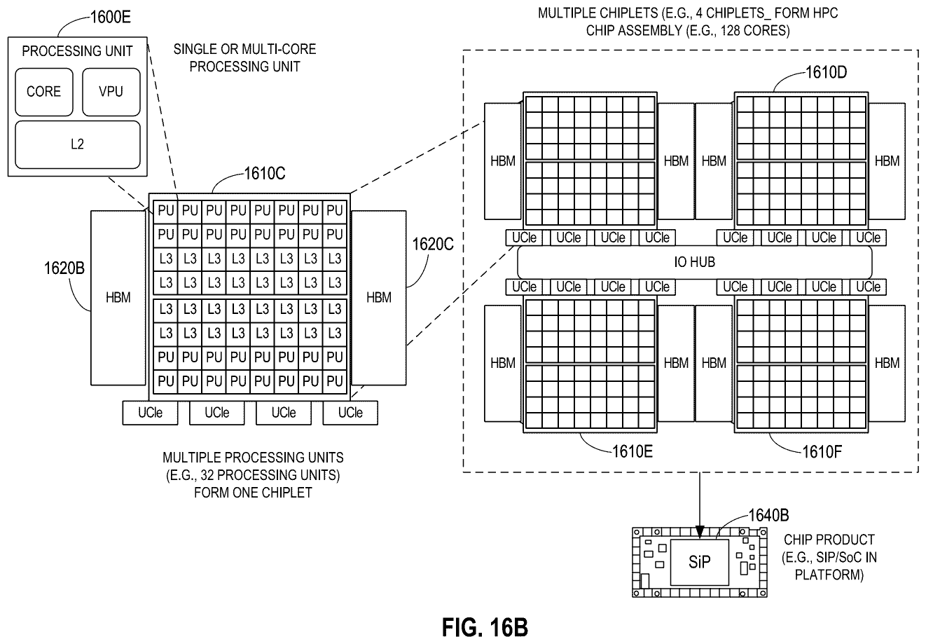

As used herein, a chiplet refers to any integrated circuit (IC) that has a modular structure designed to have one or more specified functionalities and to be combinable with one or more other chiplets on an interposer or other substrate in a package. Examples of chiplets are compute chiplets that include programmable circuitry (e.g., one or more processor circuits, such as one or more cores, etc.) and supporting circuitry (e.g., local memory, etc.) to provide computational functionality (e.g., to execute a host OS, applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example implementation of chiplets are further described below in conjunction with FIGS. 11, 16A, and 16B.

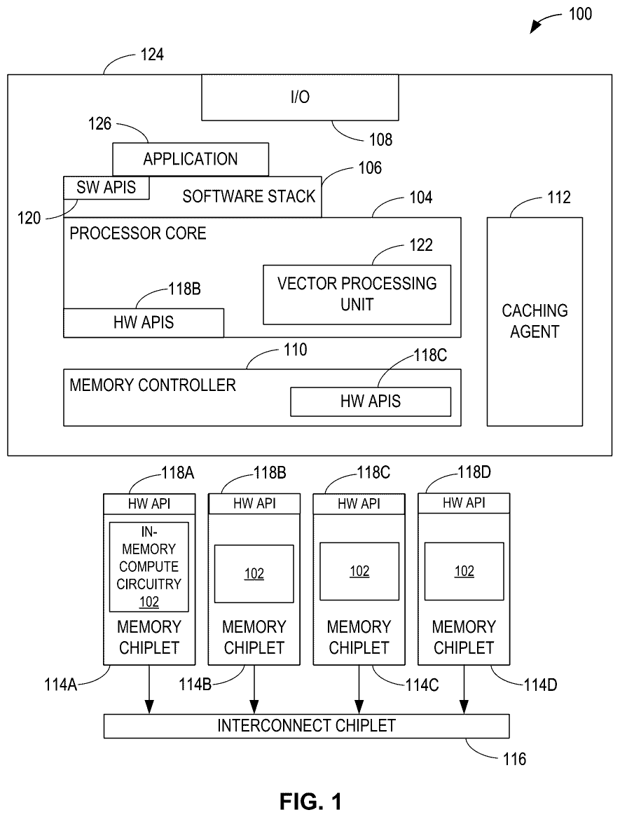

FIG. 1 is a block diagram of an example computing environment 100 in which example in-memory compute circuitry 102 operates to perform in-memory operations based on instructions from an example core 104 and an example software stack 106. The example computing environment 100 includes example input/output (I/O) circuitry 108, an example memory controller 110, an example caching agent 112, example memory chiplets 114A, 114B, 114C, 114D, and an example interconnect chiplet 116. The example processor core 104, the example software stack 106, the example I/O circuitry 108, the example memory controller 110, and the example caching agent 112 are implemented by an example compute chiplet 124.

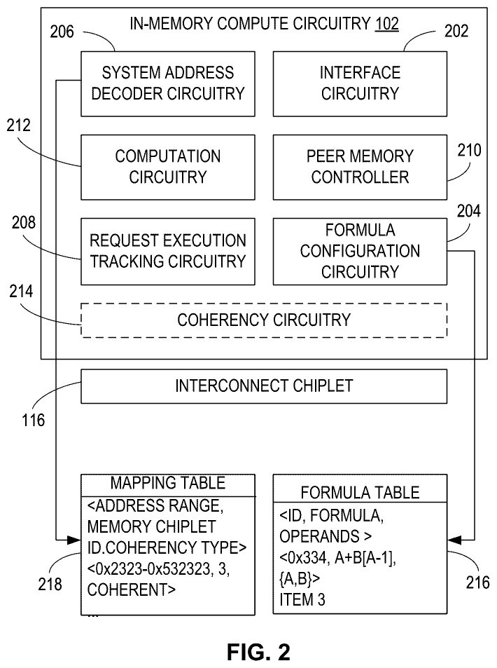

In FIG. 1, the in-memory compute circuitry 102 performs memory accesses and operations at a memory chiplet (e.g., memory chiplets 114A, 114B, 114C, 114D). The in-memory compute circuitry 102 is implemented in part or portions of the memory chiplet. For example, each memory chiplet may include programmable circuitry, dedicated logic circuits, etc., that implement the in-memory compute circuitry 102. The in-memory compute circuitry 102 interfaces with the core 104, software stack 106, and the memory controller 110 using example hardware application programming interfaces (APIs) 118A, 118B, and 118C and example software API 120. The example hardware APIs 118A, 118B, and 118C (e.g., collectively, hardware APIs 118) allow the core 104 and memory controller 110 to interact with hardware components of the memory chiplet 114A-D, while the software API 120 allows the software stack 106 to communicate with the software components of the memory chiplet 114A-D. For example, the hardware APIs 118A, 118B, and 118C and the software API 120 allow different parts of the computing environment 100 to send and receive data from the in-memory compute circuitry 102. The in-memory compute circuitry 102 is described in further detail below in connection with FIG. 2.

In FIG. 1, the core 104 executes workloads, such as matrix multiplication operations. In some examples, the core 104 communicates with the memory controller 110 to send a part or portion(s) of workloads to one of the memory chiplets 114A-D. For example, the core 104 may be a single processing unit in computing environment 100 configured to offload formulas of a workload, registered by the software stack 106. The core 104 includes an example vector processing unit 122 to process matrices of the matrix multiplication. For example, the vector processing unit 122 is specialized hardware designed to operate effectively on large arrays, including matrices of data, also referred to as vectors. The core 104 and the vector processing unit 122 operate to execute sparse matrix multiplications. The core 104 includes the HW API 118B to send and receive instructions to other components of the computing environment 100, including the memory controller 110 and the memory chiplets 114A-D.

In FIG. 1, the software stack 106 is a collection of software components that work together to support the execution of a workload. For example, the software stack 106 includes one or more programming languages, frameworks, libraries, databases, operating systems, etc., that work together to create a platform for developing and running an example application 126. An operating system may be any traditional operating system such as Linux®, Windows™, macOS®, etc., and/or any AI-powered operating system such as Windows 10® with Cortana™, Android® with Google Assistant™, iOS® with Siri®, etc., that provides functionality and manages applications (e.g., application 126) in the computing environment 100. In some examples, the operating system may include operating system modules that add particular functionality to the computing environment 100, such as registering memory access formulas, requesting memory access formulas to be executed, etc. The application 126 registers a formula to the software stack 106. The software stack 106 includes the SW API 120 to register a formula with the core 104. A formula is mathematically defined memory access of elements in a matrix. For example, to access one or more elements in a matrix using indirection, a formula may be configured for the one or more elements. Take a matrix A of dimensions m×n. The element corresponding to A[i][j] is an element in matrix A at the i-th row and the j-th column. In some examples, a formula for accessing element A[i][j] is base_address+(i×n+j)×element_size, where base_address is the starting memory address of the matrix and element_size is the size of each element in bytes. The formula includes an index (e.g., (i×n+j)) to calculate the linear index within the matrix. In some examples, formulas include constants to represent dimensions (m×n), byte size (element_size), and starting memory address (base_address) of the matrix. In some examples, formulas include parameters and/or operands to define the rows and columns ([i] and [j]) of the matrix. In some examples, the software stack 106 defines the parameters (e.g., constants) and/or operands. As described, the formulas may involve some mathematical computations. The in-memory compute circuitry 102 of the memory chiplets 114A-D performs these mathematical computations, rather than the core 104.

In FIG. 1, the I/O circuitry 108 enables communication and data transfer between the computing environment 100 and external devices. For example, the I/O circuitry 108 receives data from external devices, such as keyboards, mice, sensors, etc. The I/O circuitry 108 may output data to output devices, such as monitors, printers, network interfaces, etc. In some examples, if the core 104 is executing a matrix multiplication for a neural network, machine learning model, or any type of artificial intelligence (AI) model, the I/O circuitry 108 receives an input to the model and outputs a result to an external device.

In FIG. 1, the memory controller 110 manages and coordinates the flow of data between the core 104 and the memory chiplets 114A-D. In some examples, the memory controller 110 initiates memory read and/or memory write operations, based on instructions from the core 104 and/or the in-memory compute circuitry 102. For example, the memory controller 110 receives a formula from the core 104, and registers the formula to the memory chiplets 114A-D. As described above, “registering” a formula is offloading, enrolling, and/or associating a formula from the core 104 to/with the memory chiplets 114A-D. Such registering, offloading, and/or associating a formula with the memory chiplets 114A-D configures (e.g., prepares, enables, etc.) the memory chiplets 114A-D to execute the formula. Registering formulas is described in further detail below in connection with FIGS. 2, 3, and 4.

In FIG. 1, the caching agent 112 caches data returned from one or more of the memory chiplets 114A-D. In some examples, the caching agent 112 is configured to cache data returned from the vector processing unit 122. The caching agent 112 may be accessed by the memory controller 110 during execution of a workload. For example, the caching agent 112 caches data used by the core 104 and the vector processing unit 122, and the memory controller 110 controls the reads and writes to the caching agent 112, per requests from the core 104.

In FIG. 1, the memory chiplets 114A-D are memory modules including a series of memory chips and pins (e.g., connectors) that connect to the example compute chiplet 124 and the example interconnect chiplet 116. In some examples, the memory chiplets 114A-D are implemented by dual in-line memory modules (DIMMs). Data is stored in one more of the memory chiplets 114A-D. For example, elements of a matrix may be stored across (e.g., in multiple) memory chiplets 114A-D. In some examples, the computing environment 100 includes any number of memory chiplets 114A-D. Each of the memory chiplets 114A-D include in-line compute circuitry 102 and an interface, such as a HW API 118A. In some examples, the memory chiplets 114A-D are a group of memory for the compute chiplet 124, and the computing environment 100 may include more than one group of memory chiplets, where each group includes any number of memory chiplets.

In FIG. 1, the interconnect chiplet 116 is a communication pathway between different chiplets, such as the memory chiplets 114A-D. For example, the interconnect chiplet allows the memory chiplets 114A-D to exchange data. In some examples, the interconnect chiplet 116 is implemented by a Universal Chiplet Interconnect Express (UCIe). A UCIe is an open specification and physical protocol layer that facilitates die-to-die interconnects between chiplets (e.g., memory chiplets 114A-D) within a package (e.g., computing environment 100). In some examples, the memory chiplets 114A-D include interconnection (e.g., UCIe) connections to connect to the interconnect chiplet 116. In some examples, the in-memory compute circuitry 102 obtains data from remote memory chiplets using the interconnect chiplet 116.

FIG. 2 is a block diagram of an example implementation of the in-memory compute circuitry 102 of FIG. 1 to register and execute memory access formulas. The in-memory compute circuitry 102 of FIG. 2 may be instantiated (e.g., creating an instance of, bring into being for any length of time, materialize, implement, etc.) by programmable circuitry. For example, programmable circuitry may be implemented by a Central Processor Unit (CPU) a chiplet, an array of chiplets, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the in-memory compute circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

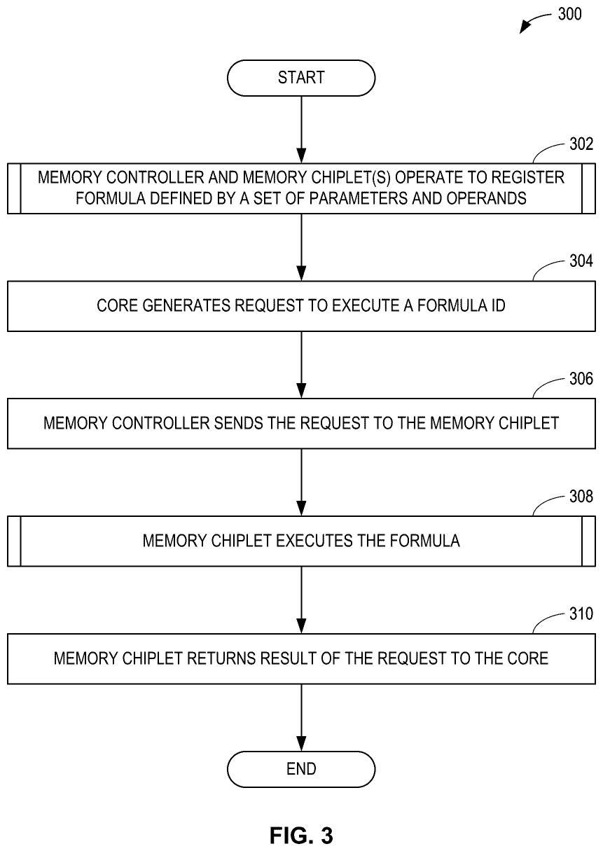

The in-memory compute circuitry 102 of FIG. 2 includes example interface circuitry 202, example formula configuration circuitry 204, example system address decoder circuitry 206, example request execution tracking circuitry 208, an example peer memory controller 210, and example compute circuitry 212. In some examples, the in-memory compute circuitry 102 includes example coherency circuitry 214. In some examples, the interface circuitry 202 is instantiated by programmable circuitry executing interface circuitry instructions and/or configured to perform operations such as those represented by the flowchart(s) of FIGS. 3, 4, 5, and 6. In some examples, the formula configuration circuitry 204 is instantiated by programmable circuitry executing formula configuration circuitry instructions and/or configured to perform operations such as those represented by the flowchart(s) of FIGS. 3, 4, 5, and 6. In some examples, the system address decoder circuitry 206 is instantiated by programmable circuitry executing system address decoder circuitry instructions and/or configured to perform operations such as those represented by the flowchart(s) of FIGS. 3, 4, 5, and 6. In some examples, the request execution tracking circuitry 208 is instantiated by programmable circuitry executing request execution tracking circuitry instructions and/or configured to perform operations such as those represented by the flowchart(s) of FIGS. 3, 4, 5, and 6. In some examples, the peer memory controller 210 is instantiated by programmable circuitry executing peer memory controller instructions and/or configured to perform operations such as those represented by the flowchart(s) of FIGS. 3, 4, 5, and 6. In some examples, the compute circuitry 212 is instantiated by programmable circuitry executing compute circuitry instructions and/or configured to perform operations such as those represented by the flowchart(s) of FIGS. 3, 4, 5, and 6. In some examples, the coherency circuitry 214 is instantiated by programmable circuitry executing coherency circuitry instructions and/or configured to perform operations such as those represented by the flowchart(s) of FIGS. 3, 4, 5, and 6.

In FIG. 2, the interface circuitry 202 obtains formula registering instructions and formula execution instructions from the memory controller 110 (FIG. 1) and forwards the instructions to respective circuitry. For example, the interface circuitry 202 obtains formula registering instructions and forwards the instructions to the formula configuration circuitry 204. In some examples, the interface circuitry 202 obtains formula execution instructions and forwards the instructions to the request execution tracking circuitry 208. In some examples, the interface circuitry 202 is implemented by the HW API 118A. In some examples, the interface circuitry 202 provides telemetry data to the memory controller 110. The telemetry data corresponds to the traces, spans, and metrics (e.g., performance characteristics) of the respective memory chiplet 114. In some examples, the memory controller 110 uses the telemetry data to perform load balancing when sending a request to execute a memory access formula. For example, the memory controller 110 uses telemetry data to determine which memory chiplet 114A-D has capacity to execute the memory access formula.

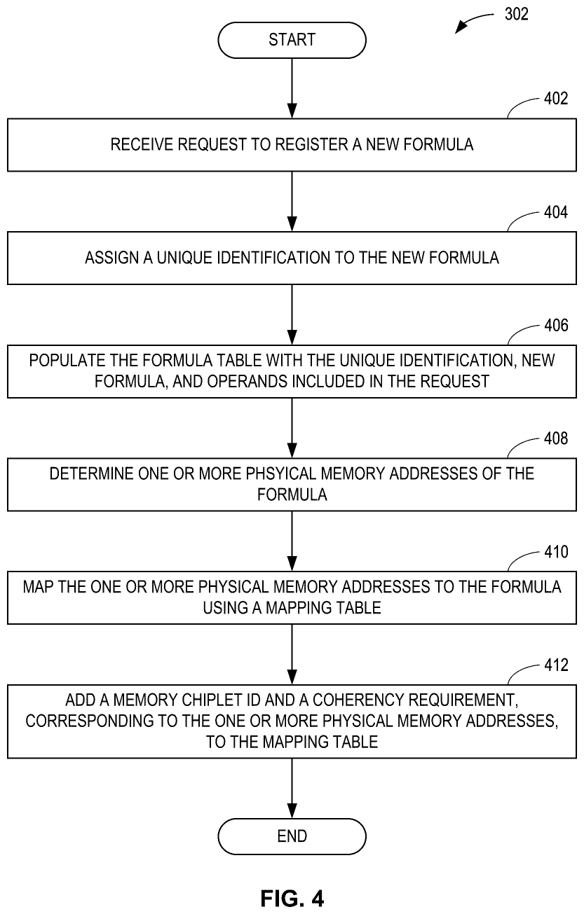

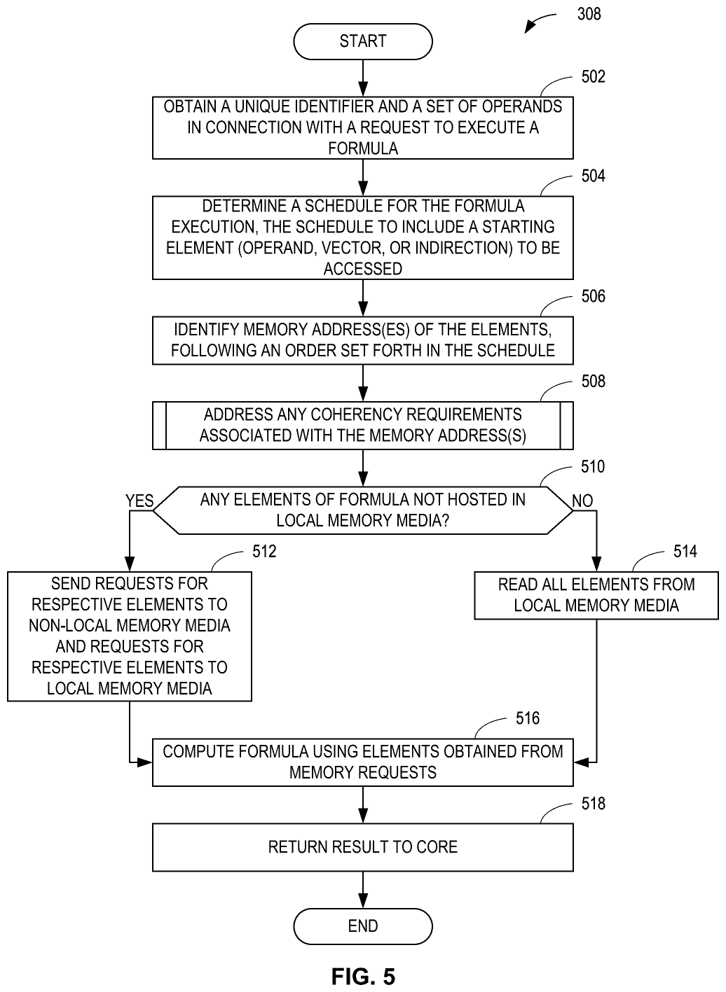

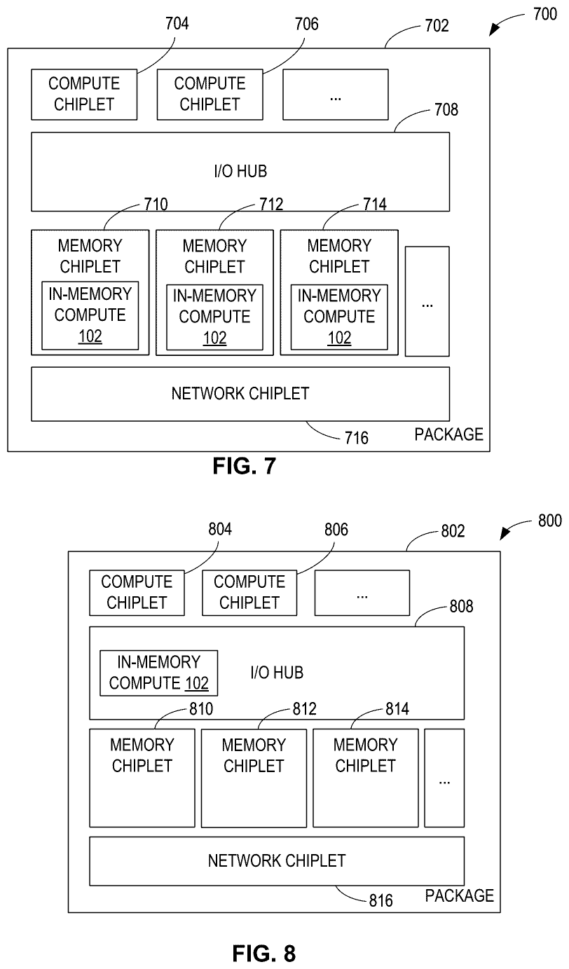

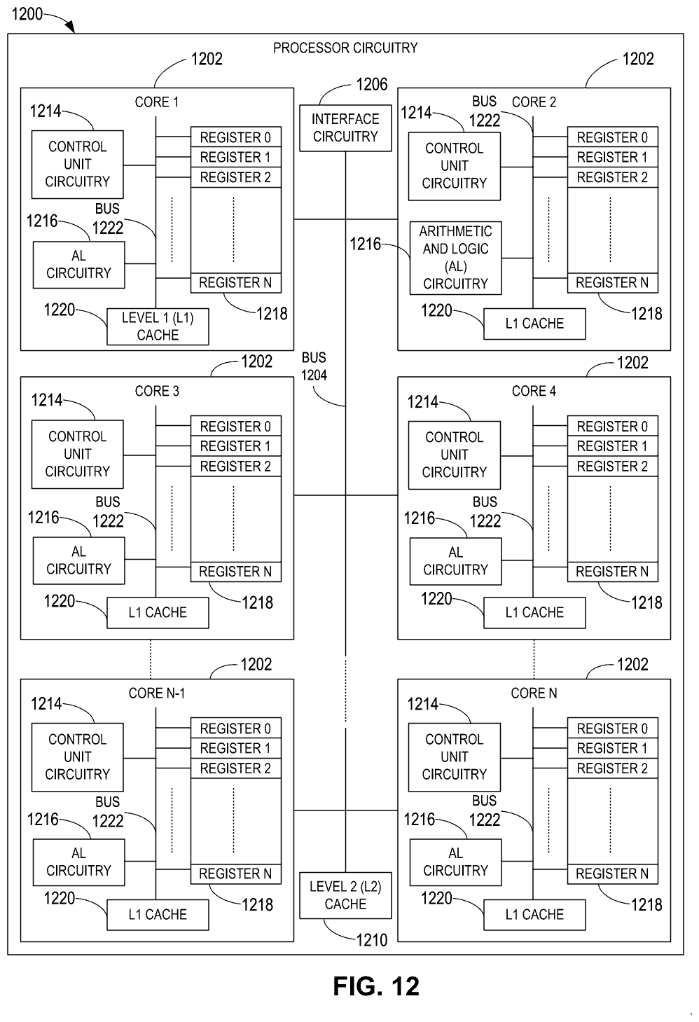

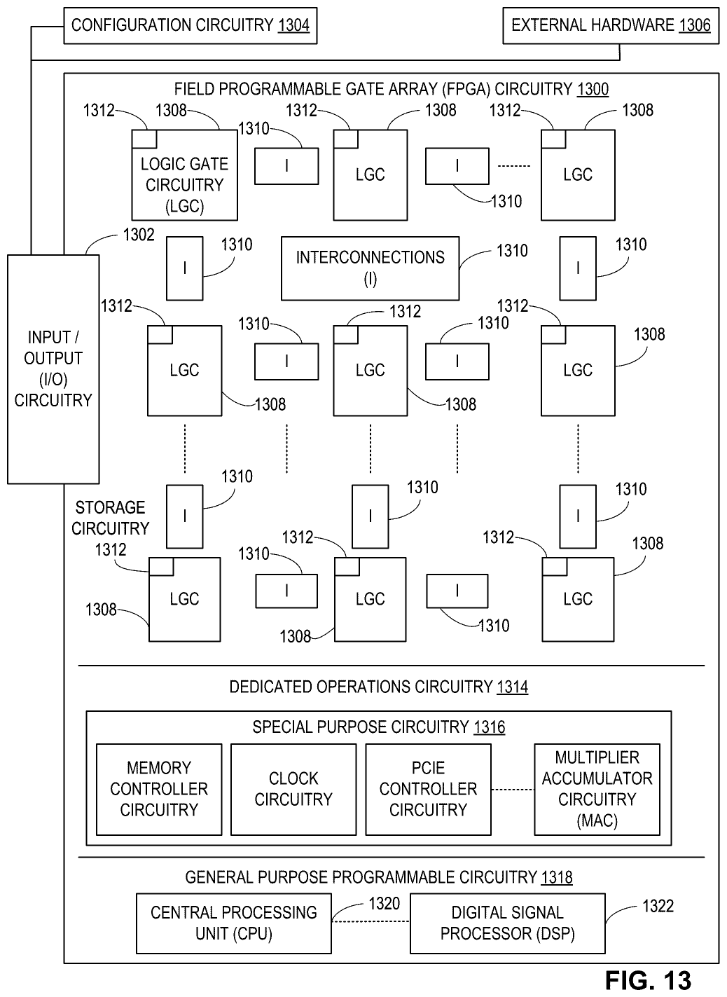

In some examples, the in-memory compute circuitry 102 includes means for obtaining instructions to register and execute formulas. For example, the means for obtaining instructions to register and execute formulas may be implemented by interface circuitry 202. In some examples, the interface circuitry 202 may be instantiated by programmable circuitry such as the example programmable circuitry 1112 of FIG. 7. For instance, the interface circuitry 202 may be instantiated by the example microprocessor 1200 of FIG. 12 and/or the chiplet of FIGS. 16A and/or 16B executing machine executable instructions such as those implemented by at least block 402 of FIG. 4 and block 502 of FIG. 5. In some examples, the interface circuitry 202 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the interface circuitry 202 may be instantiated by any other combination of hardware, software, and/or firmware. For example, the interface circuitry 202 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In FIG. 2, the formula configuration circuitry 204 configures a given memory chiplet with a memory access formula. To configure the memory chiplet with a memory access formula, the formula configuration circuitry 204 identifies the formula with a universally unique identifier (UUID). For example, the software stack 106 (FIG. 1) defines a memory access formula and assigns the formula a UUID, and the formula configuration circuitry 204 uses the UUID to identify and store the formula. The formula configuration circuitry 204 stores memory access formulas in an example formula table 216. In some examples, the example formula table 216 is data structure, a hardware register, and/or any other data storage structure dedicated and/or configured to store memory access formulas. The terms “hardware register” and “register a formula” or “registering a formula” are different, such that any reference to a hardware register is described as a “hardware register” rather than just a “register”. In some examples, the formula table 216 stores memory access formulas in a specific format. For example, an item in the formula table 216 may be stored as <ID, formula, operands>, where “ID” corresponds to the formula's unique identifier, “formula” corresponds to the mathematical operation, and “operands” correspond to the row(s) and column(s) defined by the software stack 106. In FIG. 2, item 3 of the formula table stores a memory access formula <0x334, A+B[A−1], {A, B}>, where “0x334” is a unique identifier in a hexadecimal representation, “A+B[A−1]” is the mathematical operation to access the data at the specific memory location, and “A” and “B” are the operands defined by the software stack 106. In some examples, the formula configuration circuitry 204 configures any number of memory access formulas for any number of memory chiplets.

In some examples, the in-memory compute circuitry 102 includes means for registering a formula. For example, the means for registering a formula may be implemented by formula configuration circuitry 204. In some examples, the formula configuration circuitry 204 may be instantiated by programmable circuitry such as the example programmable circuitry 1112 of FIG. 11. For instance, the formula configuration circuitry 204 may be instantiated by the example microprocessor 1200 of FIG. 12 executing machine executable instructions such as those implemented by at least blocks 302 of FIG. 3 and blocks 404 and 406 of FIG. 4. In some examples, the formula configuration circuitry 204 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the formula configuration circuitry 204 may be instantiated by any other combination of hardware, software, and/or firmware. For example, the formula configuration circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In FIG. 2, the system address decoder circuitry 206 configures hardware address range mapping of the formulas. For example, the memory access formula represents virtual memory addresses of element(s) in a matrix, array, vector, etc. The system address decoder circuitry 206 determines the physical address of a given virtual memory address, and maps the virtual memory address to the physical address. In some examples, the system address decoder circuitry 206 decodes memory addresses of formulas when the formula configuration circuitry 204 registers the formula. The system address decoder circuitry 206 generates a mapping table 218 to store the decoded memory addresses corresponding to the memory access formulas. In some examples, the mapping table 218 is a lookup table (LUT) stored in a hardware register and/or other data storage structure, in the memory units in the memory chiplet 114, etc. In some examples, the mapping table 218 stores decoded memory addresses in a specific format. For example, an item in the mapping table 218 may be stored as <Address Range, Memory Chiplet ID, coherency type>, where “Address Range” corresponds to the set of contiguous memory addresses that define the specific, physical region of memory in a memory chiplet 114, “Memory Chiplet ID” corresponds to the memory chiplet containing the Address Range, and “coherency type” corresponds to whether the Address Range has a coherency requirement. The coherency requirement of an Address Range is described in further detail below.

In FIG. 2, the mapping table 218 stores a decoded memory address for an operand of the formula in item 3 of the formula table 216 as <0x2323-0x532323, 3, coherent>, where “0x2323-0x532323” is the physical address range in a hexadecimal representation allocated to an operand of the formula having ID 0x334, “3” is the third memory chiplet 114C containing the physical address range, and “coherent” indicates that the address range of the operand has a coherency requirement. Every operand of the formula has a memory address decoded. A n operand refers to the address that points to a data point in memory to be used in the formula computation. As described below, during execution of the formula, the system address decoder circuitry 206 informs the peer memory controller 210 whether data of a formula is located in the local memory chiplet or a remote memory chiplet. For example, if the in-memory compute circuitry 102 of first memory chiplet 114A performs execution of the formula, then the system address decoder circuitry 206 determines that formula ID 0x334 is in a remote memory chiplet relative to the memory chiplet executing the formula (because the mapping table 218 indicates the physical address range allocated to the formula is associated with the third memory chiplet 114C), while a formula ID mapped to memory chiplet 1, which corresponds to the first memory chiplet 114A, is located in the local memory chiplet.

In some examples, the in-memory compute circuitry 102 includes means for identifying physical memory addresses of a formula. For example, the means for identifying one or more physical memory addresses of a formula may be implemented by system address decoder circuitry 206. In some examples, the system address decoder circuitry 206 may be instantiated by programmable circuitry such as the example programmable circuitry 1112 of FIG. 11. For instance, the system address decoder circuitry 206 may be instantiated by the example microprocessor 1200 of FIG. 12 and/or the chiplet of FIGS. 16A and/or 16B executing machine executable instructions such as those implemented by at least blocks 408, 410, and 412 of FIG. 4 and/or blocks 506 of FIG. 5. In some examples, the system address decoder circuitry 206 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the system address decoder circuitry 206 may be instantiated by any other combination of hardware, software, and/or firmware. For example, the system address decoder circuitry 206 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In FIG. 2, the request execution tracking circuitry 208 schedules memory accesses and formula execution. In some examples, the request execution tracking circuitry 208 obtains a request or an instruction from the memory controller 110 to execute a formula, and schedules the execution of the formula based on an order. For example, the request execution tracking circuitry 208 determines a schedule for the formula execution based on an order of operations of the formula. The order of operations may be predetermined, or may be default, such as the Parenthesis, Exponents, Multiplication or Division, Adding or Subtracting (PEMDAS) rule. The order of operations determines which vector or operand will be accessed first, then which will be accessed second, and so on. In some examples, the request execution tracking circuitry 208 determines a schedule for the formula, selects the first operation in the order, and identifies the physical address range of the selected operation. For example, in formula ID 0x334, the request execution tracking circuitry 208 schedules [A−1] to be executed first, schedules B[A−1] to be executed second, and schedules A+B[A−1] to executed third. In this example, the request execution tracking circuitry 208 determines the address range of vector “[A−1]” first, obtains the data in the address range of vector “[A−1]”, then determines the address range of operand “B” to obtain the data in the address range of operand “B” to send to the compute circuitry 212 to execute operation B[A−1], and lastly determines the address range of operand “A” to obtain the data in the address range of operand “A” to schedule the compute circuitry 212 to execute operation A+B[A−1]. In some examples, the request execution tracking circuitry 208 may communicate with the peer memory controller 210 to identify the address ranges of vectors and/or operands. In some examples, the request execution tracking circuitry 208 sends a result of the formula to the memory controller 110 of compute chiplet 124. In some examples, the in-memory compute circuitry 102 includes means for determining a schedule for a formula execution. For example, the means for determining a schedule for a formula execution may be implemented by request execution tracking circuitry 208. In some examples, the request execution tracking circuitry 208 may be instantiated by programmable circuitry such as the example programmable circuitry 1112 of FIG. 11. For instance, the request execution tracking circuitry 208 may be instantiated by the example microprocessor 1200 of FIG. 12 and/or the chiplet of FIGS. 16A and/or 16B executing machine executable instructions such as those implemented by at least block 504 of FIG. 5. In some examples, the request execution tracking circuitry 208 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the request execution tracking circuitry 208 may be instantiated by any other combination of hardware, software, and/or firmware. For example, the request execution tracking circuitry 208 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In FIG. 2, the peer memory controller 210 uses the system address decoder circuitry 206 and mapping table 218 to identify which memory chiplet 114A-D and physical address range the elements of a formula are in and obtain the data from memory chiplet 114A-D. In some examples, when the elements are hosted locally (e.g., are located in the same memory chiplet as the peer memory controller 210), the peer memory controller 210 accesses local media to obtain the elements. In some examples, when the elements are hosted at remote memory chiplets 114B-D, the peer memory controller 210 sends a request for data to the remote memory chiplet using the interconnect chiplet 116. In some examples, the peer memory controller 210 attends to requests from remote peer memory controllers. For example, the peer memory controller 210 is a first peer memory controller implemented by the first memory chiplet 114A and the second memory chiplet 114B implements a second peer memory controller 210, the third memory chiplet 114C implements a third peer memory controller 210, and the fourth memory chiplet 114D implements a fourth peer memory controller 210. The first peer memory controller 210 attends to requests from the second, third, and fourth peer memory controllers when the first memory chiplet 114A hosts data elements to be used to execute operations offloaded to the second, third, and/or fourth memory chiplets 114B-D.

In some examples, the in-memory compute circuitry 102 includes means for sending requests for data to local and remote memory chiplets. For example, the means for sending requests for data to local and remote memory chiplets may be implemented by peer memory controller circuitry 210. In some examples, the peer memory controller circuitry 210 may be instantiated by programmable circuitry such as the example programmable circuitry 1112 of FIG. 11. For instance, the peer memory controller circuitry 210 may be instantiated by the example microprocessor 1200 of FIG. 12 and/or the chiplet of FIGS. 16A and/or 16B executing machine executable instructions such as those implemented by at least blocks 510, 512, and 514 of FIG. 5. In some examples, the peer memory controller circuitry 210 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the peer memory controller circuitry 210 may be instantiated by any other combination of hardware, software, and/or firmware. For example, the peer memory controller circuitry 210 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In FIG. 2, the compute circuitry 212 executes a request to execute (e.g., evaluate) a formula. The compute circuitry 212 fetches the formula to be executed based on the formula ID. The compute circuitry 212 starts the execution of the formula in response to the request execution tracking circuitry 208. In some examples, the compute circuitry 212 performs mathematical operations, such as additions, subtractions, divisions, multiplications, etc. In some examples, the compute circuitry 212 is implemented by logic gates, accumulators, one or more hardware registers, and/or any other electronic components that are configured to process a formula execution request.

In some examples, the in-memory compute circuitry 102 includes means for computing a formula using data accessed from memory requests. For example, the means for computing a formula using data accessed from memory requests may be implemented by compute circuitry 212. In some examples, the compute circuitry 212 may be instantiated by programmable circuitry such as the example programmable circuitry 1112 of FIG. 11. For instance, the compute circuitry 212 may be instantiated by the example microprocessor 1200 of FIG. 12 and/or the chiplet of FIGS. 16A and/or 16B executing machine executable instructions such as those implemented by at least block 308 of FIG. 3 and/or blocks 516 and 518 of FIG. 5. In some examples, the compute circuitry 212 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the compute circuitry 212 may be instantiated by any other combination of hardware, software, and/or firmware. For example, the compute circuitry 212 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

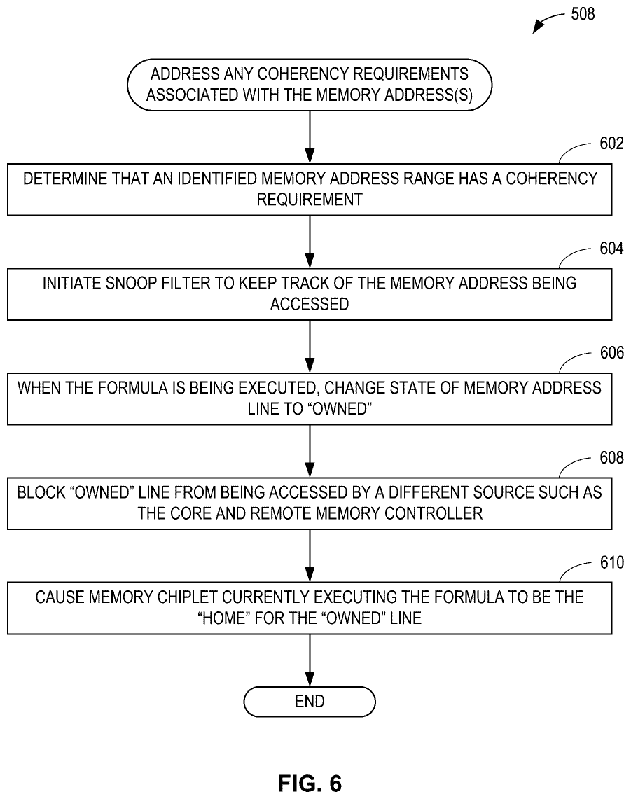

In FIG. 2, the coherency circuitry 214 implements coherency access when a memory address range has a coherency requirement. Memory coherence is a protocol applied when two or more cores share a common area of memory. A coherency requirement means that multiple cores accessing the common area of memory observe the same value at any given time, ensuring consistency across the cores, even if the cores have cached copies of the data. For example, if one core updates a value at a certain physical memory address, the other cores accessing that physical memory address should see the updated value as well, preventing conflicting data states. A coherency requirement means that a memory coherence protocol is to be implemented for that memory address range. Various protocols have been devised for maintaining coherence, such as modified-shared-invalid (MSI), modified-exclusive-shared-invalid (MESI), modified-owned-shared-invalid (MOSI), modified-owned-exclusive-shared-invalid (MOESI), modified-exclusive-read-only or recent-shared-invalid (MERSI), modified-exclusive-shared-invalid-forward (MESIF), write-once, etc. The coherency circuitry 214 may implement any type of coherency protocol or combination of coherency protocols. The flowchart described below in connection with FIG. 6 describes a MOSI-type protocol, but the coherency circuitry 214 is not limited to such a protocol.

In some examples, the coherency circuitry 214 includes a snoop filter to implement snooping. Snooping is a process where individual cache lines monitor address lines for accesses to memory locations that they have cached. Coherency protocols can be classified as snoop-based, where the transaction requests (to read, write, or upgrade) are sent out to multiple cores and the cores “snoop” the requests and respond appropriately. For example, when the first peer memory controller 210 sends a request to read data from a local or remote memory media address that is shared by all memory chiplets 114A-D, the coherency circuitry 214 of the first, second, third, and fourth memory chiplets 114A-D snoops (e.g., monitors) that request and responds appropriately. In some examples, responding appropriately depends on the type of coherency protocol implemented. For example, the coherency circuitry 214 may update the copy in the respective memory chiplet 114 to reflect a change, may change a state of the memory address, may block the memory address from being read from or written to, etc. In some examples, the coherency circuitry 214 is invoked when a physical memory address range has a coherency requirement. Therefore, the coherency circuitry 214 may not be invoked for each formula execution request.

In some examples, the in-memory compute circuitry 102 includes means for implementing memory coherency requirements. For example, the means for implementing memory coherency requirements may be implemented by coherency circuitry 214. In some examples, the coherency circuitry 214 may be instantiated by programmable circuitry such as the example programmable circuitry 1112 of FIG. 11. For instance, the coherency circuitry 214 may be instantiated by the example microprocessor 1200 of FIG. 12 and/or the chiplet of FIGS. 16A and/or 16B executing machine executable instructions such as those implemented by at least block 508 of FIG. 5 and/or blocks 604, 606, 608, and 610 of FIG. 6. In some examples, the coherency circuitry 214 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the coherency circuitry 214 may be instantiated by any other combination of hardware, software, and/or firmware. For example, the coherency circuitry 214 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In an example formula registering operation of the computing environment 100, the software stack 106 generates a first memory access formula A+B[A−1] to be registered with the memory chiplets 114A-D. The software stack 106 registers the first memory access formula with the core 104 using an instruction set architecture (ISA). An ISA is a model of a computer that defines how a central processing unit (CPU) is controlled by the software (e.g., the software stack 106). In some examples, the ISA of the computing environment 100 provides an interface that facilitates registering and executing memory access formulas at the memory chiplets 114A-D. For example, the interface may be implemented by the HW API 118B and allows the software stack 106 to specify the formulas, input parameters and operands, where to store a result of a memory access formula execution returned from the memory chiplets 114A-D, and if the result of the memory access needs to be accessed coherently. In some examples, the software stack 106 is expanded, relative to a software stack 106 implemented by a computing environment without in-memory compute circuitry 102, to include APIs that can access the functionality provided by the HW API 118B. For example, the SW API 120 may include a library for specifying data related to formula registering and execution, may provide operating system modules that perform the specific set of functions to facilitate registering and executing a formula, etc.

In response to the software stack 106 registering the first formula with the core 104, the core 104 sends the first formula to the memory controller 110, so the memory controller 110 can distribute the first formula to the memory chiplets 114A-D. In some examples, the memory controller 110 registers the first formula to all of the memory chiplets 114A-D. For example, the memory controller 110 sends the first formula A+B[A−1], input operands A and B, and coherency requirement of the first formula to the HW interfaces 118A of the memory chiplets 114A-D. The formulas are to be registered at all the memory chiplets 114A-D to ensure that any memory chiplet 114A-D can execute the formula upon an execution request by the memory controller 110. For example, the memory controller 110 may not know where data of the formula is stored and, thus, performs load balancing to determine which memory chiplet 114A-D is to execute the formula. That is, depending on a load at the first memory chiplet 114A, the memory controller 110 may determine that the second memory chiplet 114B has a greater capacity to execute a formula, even though the first memory chiplet 114A, the third memory chiplet 114C, or the fourth memory chiplet 114D stores the data. In some examples, the memory controller 110 registers the formula with some or all of the memory chiplets 114A-D to ensure that memory accesses are dynamic and not restricted to one particular memory chiplet.

In response to the HW API 118A obtaining a request to register the first formula from the memory controller 110, the HW API 118A sends the request to the in-memory compute circuitry 102. The interface circuitry 202 (FIG. B) obtains the request to register the first formula with the memory chiplets 114A-D. The interface circuitry 202 forwards the request to the formula configuration circuitry 204. The formula configuration circuitry 204 populates the formula table 216 with the first formula. The formula configuration circuitry 204 maps the first formula to a unique ID and any operands defined by the software stack 106 so that in the future during formula execution, the first formula can be found quickly with the use of just operands and the unique ID, rather than the first formula as a whole. For example, the formula configuration circuitry 204 maps the first formula to the unique ID 0x334 and corresponding operands A and B of the first formula. The unique ID is either provided by the software stack 106 or generated by the formula configuration circuitry.

In response to the formula configuration circuitry 204 storing the first formula in the formula table 216, the system address decoder circuitry 206 determines the physical addresses of the operands in the first formula. For example, the system address decoder circuitry 206 maps hardware address ranges to operands of the first formula. In some examples, the system address decoder circuitry 206 determines the physical address range and the memory chiplet associated with that physical address range. In the example described above, the system address decoder circuitry 206 determined that the physical address range for an operand of the first formula is in the third memory chiplet 114C. The system address decoder circuitry 206 updates the mapping table 218 to include the physical address range and chiplet identifier of all operands of the first formula, along with coherency requirements, if any, provided by the software stack 106. The formula registering operation is then complete as the system address decoder circuitry 206 has decoded the physical address ranges of the operands of the first formula and updated the mapping table 218.

In an example formula execution operation, the software stack 106 determines that the previously registered first formula is to be executed. For example, in the example described above, the software stack 106 indicates that an element of a particular matrix, vector, array, etc., located in virtual memory at A+B[A−1], is to be accessed by the core 104 and used for a matrix multiplication operation. The software stack 106 sends the core 104 operands A and B of the first formula, along with a value indicating how the in-memory compute circuitry 102 is to return the memory access to the core 104. In this example, the software stack 106 provides the operands A and B, rather than both the operands and the first formula A+B[A−1], to the core 104 because the first formula has already been registered at the memory chiplets 114A-D. Also, the software stack 106 provides the return type value (e.g., −1, 1, 0, etc.) indicating whether the in-memory compute circuitry 102 is to return the memory access to the core 104 as a regular memory read, as a memory write, and/or any other return mechanism. For example, if the software stack 106 provides a−1 with the input operands A and B, the in-memory compute circuitry 102 is to return a result of the executed first formula to the core 104 as a regular memory read.

The core 104 sends the operands A and B and the return type value to the memory controller 110. The memory controller 110 performs load balancing to determine which memory chiplet 114A-D has capacity to execute the first formula. For example, the memory controller 110 monitors bandwidth and compute resource usage at each of the memory chiplets 114A-D and selects the first memory chiplet 114A based on its bandwidth and compute resource usage. The in-memory compute circuitry 102 of the first memory chiplet 114A obtains the parameters and return type value. For example, the interface circuitry 202 obtains the operands A and B and return type value −1.

The request execution tracking circuitry 208 uses operands A and B to determine the formula to be executed. For example, the request execution tracking circuitry 208 identifies the unique identifier associated with the operands A and B, and therefore uses the formula table 216 to identify the formula A+B[A−1]. The request execution tracking circuitry 208 then schedules the execution of the first formula based on an order of operations. For example, the request execution tracking circuitry 208 determines an order of accessing data identified by the operands (e.g., data identified by the indirections). In the example described above, the request execution tracking circuitry 208 determines the compute circuitry 212 is to start by accessing data at operand A first, then computing A−1, accessing data at indirection B[A−1] next, and lastly computing A+B[A−1].

In the formula execution operation and in view of the example provided above, the compute circuitry 212 obtains the schedule (e.g., the order of operations) and first identifies the physical memory address of operand A using the mapping table 218. The compute circuitry 212 may determine that the physical address of operand A is locally stored in the first memory chiplet 114A, or determine that the physical address of operand A is located remotely in the second, third, or fourth memory chiplet 114B, 114C, 114D. The peer memory controller 210 fetches the data, whether located locally or remotely. In this example, operand A points to data in an address range located remotely at the third memory chiplet 114C. The peer memory controller 210 sends a request to the third memory chiplet 114C for data at the physical address range, using the interconnect chiplet 116. The in-memory compute circuitry 102 of the third memory chiplet 114C accesses the data in the physical address range corresponding to operand A, and sends the data, via the interconnect chiplet 116, to the peer memory controller 210 of the first memory chiplet 114A executing the first formula. The compute circuitry 212 subtracts 1 from the data accessed at operand A, then identifies data of vector or matrix B at index [A−1]. For example, the compute circuitry 212 uses the mapping table 218 to identify the physical address range for operand B at index [A−1]. The peer memory controller 210 accesses the data from the physical address range and the compute circuitry 212 adds the data to A.

The compute circuitry 212 returns the result of A+B[A−1] to the core 104 in the specified return type (e.g., as a regular memory read). The core 104 uses the data in whatever capacity the software stack 106 has defined. In some examples, if the compute circuitry 212 determines that a coherency is required for any data stored in specified address ranges, the coherency circuitry 214 initiates a coherency protocol. For example, the coherency circuitry 214 may trigger activation of a snoop filter to monitor the physical memory address being accessed. The coherency circuitry 214 may change the state of the memory address line being accessed to “owned”. The coherency circuitry 214 may additionally block the “owned” line from being accessed by a different source, such as the core 104, the memory controller 110, or a different peer memory controller 210. In some examples, to block the “owned” line from being accessed by a different source, the coherency circuitry 214 flags the memory chiplet 114A to be the “HOME” for the “owned” line. For example, the memory chiplet designated as “HOME” for the “owned” line will not be blocked from accessing that line, but any other memory chiplet will be blocked.

The formula execution operation is complete when the in-memory compute circuitry 102 returns the result of the first formula to the core 104.

While an example manner of implementing the in-memory compute circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 202, the example formula configuration circuitry 204, the example system address decoder circuitry 206, the example request execution tracking circuitry 208, the example peer memory controller 210, the example computation circuitry 212, the example coherency circuitry 214, and/or, more generally, the example in-memory compute circuitry 102 of FIG. 2, may be implemented by hardware alone or by hardware in combination with software and/or firmware. Thus, for example, any of the example interface circuitry 202, the example formula configuration circuitry 204, the example system address decoder circuitry 206, the example request execution tracking circuitry 208, the example peer memory controller 210, the example computation circuitry 212, the example coherency circuitry 214, and/or, more generally, the example in-memory compute circuitry 102, could be implemented by programmable circuitry such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing unit(s) (VPUs), and/or field programmable logic device(s) (FPLD(s)) such as FPGAs in combination with machine readable instructions (e.g., firmware or software). Further still, the example in-memory compute circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the in-memory compute circuitry 102 of FIG. 2 and/or representative of example operations which may be performed by programmable circuitry to implement and/or instantiate the in-memory compute circuitry 102 of FIG. 2, are shown in FIGS. 3-6. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a memory register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-6, many other methods of implementing the example in-memory compute circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, chiplet(s), discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or an array of chiplets, etc.)). As used herein, programmable circuitry includes any type(s) of circuit that may be programmed to perform a desired function such as, for example, a CPU, a core, a chiplet, an array of chiplets, a GPU, a VPU, and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more one or more CPUs, one or more cores, one or more chiplets, one or more GPUs, one or more VPUs, and/or one or more FPGAs in a single machine, multiple CPUs, cores, chiplets, GPUs, VPUs, and/or FPGAs distributed across multiple servers of a server rack, and/or multiple CPUs, cores, chiplets, GPUs, VPUs, and/or FPGA s distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a memory register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to implement the in-memory compute circuitry 102 to register and execute memory access formulas. The example machine-readable instructions and/or the example operations 300 of FIG. 3 begin at block 302, at which the memory controller 110 (FIG. 1) and memory chiplets 114A-D (FIG. 1) operate to register a formula defined by a set of parameters and operands. For example, the memory controller 110 sends a memory access formula to the memory chiplets 114A-D with a set of operands and a unique identifier. The memory chiplets 114A-D register the formula with the identifier in a formula data structure (e.g., the formula table 216 of FIG. 2). Block 302 is described in further detail below in connection with FIG. 4.

At block 304, the core 104 generates a request to execute a formula. For example, the software stack 106 instructs the core 104 to perform a matrix multiplication operation. The instruction includes one or more memory access formulas. The core 104 generates the memory access request for one of the one or more memory access formulas.

At block 306, the memory controller 110 sends the request to a memory chiplet 114. For example, the memory controller 110 performs load balancing and identifies one of the memory chiplets 114A-D that can handle the request.

At block 308, the memory chiplet 114 executes the formula. For example, the in-memory compute circuitry 102 accesses data for the matrix multiplication operation by executing the formula. Block 308 is described in further detail below in connection with FIG. 5.

At block 310 the memory chiplet 114 returns the result of the request to the core 104. For example, the in-memory compute circuitry 102 returns the data accessed from the formula to the core 104 for performing the matrix multiplication.

Turning to FIG. 4, a flowchart representative of example machine readable instructions and/or example operations 302 is illustrated that may be executed, instantiated, and/or performed by programmable circuitry to implement the in-memory compute circuitry 102 to register a memory access formula with the memory chiplets 114A-D. The example machine-readable instructions and/or the example operations 302 of FIG. 4 begin at block 402, at which the interface circuitry 202 receives a request to register a new formula. For example, the interface circuitry 202 receives a request from the memory controller 110 of the compute chiplet 124.

At block 404, the formula configuration circuitry 204 assigns a unique identifier to the new formula. For example, the formula configuration circuitry 204 either receives a unique ID in the request (from the memory controller 110) or generates a unique ID for the formula. In some examples, the unique ID is used to identify the formula in a subsequent formula execution request as well as to maintain consistency across the memory chiplets 114A-D.

At block 406, the formula configuration circuitry 204 populates the formula table 216 with the unique ID, new formula, and any parameters included in the request. For example, the formula configuration circuitry 204 stores the new formula in the formula table 216 with an identifier and associated operands. In some examples, the software stack 106 provides the operands that are included in the formula, and the memory controller 110 sends the formula and operands to the in-memory compute circuitry 102. In some examples, the formula configuration circuitry 204 populates a data structure of the first memory chiplet (114A), a second memory chiplet (114B), a third memory chiplet (114C), and a fourth memory chiplet (114D) with registered formulas, the registered formulas including the identifier, the formula, and one or more operands.

At block 408, the system address decoder circuitry 206 determines one or more physical memory addresses of the formula. For example, the system address decoder circuitry 206 may be triggered to decode the physical memory address range from a virtual memory address when the formula configuration circuitry 204 generates and/or populates the formula table 216. In some examples, the system address decoder circuitry 206 to uses the data structure (e.g., the formula table 216) to identify the formula and determine one or more memory addresses storing one or more operands of the formula. In some examples, the system address decoder circuitry 206 determines the one or more physical memory addresses based on virtual memory decoding. In some examples, virtual memory decoding includes using a page table that maps virtual addresses to physical addresses. During virtual memory decoding, the system address decoder circuitry 206 uses the virtual memory addresses of the formula to look up the physical memory addresses in the page table. In some examples, a formula includes a plurality of virtual memory addresses. For example, a virtual memory address may be represented by character “A” corresponding to an operand in the formula, character “B” corresponding to an operand in the formula, characters “B[i]” corresponding to a vector in the formula, etc.

At block 410, the system address decoder circuitry 206 maps the one or more physical memory addresses to the formula using the mapping table 218. For example, after performing the process of virtual memory address decoding, the physical memory addresses are stored in a mapping table 218 for quick access during formula execution. Additionally and/or alternatively, the system address decoder circuitry 206 performs virtual memory address decoding on the fly (e.g., during formula execution and not formula registering). For example, the system address decoder circuitry 206 may identify the physical memory address range of an operand, vector, indirection, etc., when the computation circuitry 212 is computing the formula, and the mapping table 218 is a page table.

At block 412, the system address decoder circuitry 206 adds a memory chiplet ID and a coherency requirement, corresponding to the one or more physical memory addresses, to the mapping table 218. For example, the system address decoder circuitry 206 identifies which memory chiplet 114 the physical memory address is located, and stores the identifier of that memory chiplet 114 with the physical memory address range. In this way, the peer memory controller 210 understands when to send a request for data through the interconnect chiplet 116 and when to send a request for data locally. The system address decoder circuitry 206 additionally stores the coherency requirement of the formula with the physical memory address range.

The operations 302 of FIG. 4 end when the formula table 216 and mapping table 218 have been updated with information corresponding to the new formula. In some examples, the operations 302 of FIG. 4 may be repeated when the memory controller 110 requests to register another formula.

Turning to FIG. 5, a flowchart representative of example machine readable instructions and/or example operations 308 is illustrated that may be executed, instantiated, and/or performed by programmable circuitry to implement the in-memory compute circuitry 102 to execute a memory access formula. The example machine-readable instructions and/or the example operations 308 of FIG. 5 begin at block 502, at which the interface circuitry 202 obtains a unique identifier and a set of operands in connection with a request to execute a formula. For example, instead of sending the entire formula, the memory controller 110 sends the operands associated with the formula, along with the corresponding unique ID. In some examples, the memory controller 110 does not send the unique ID with the set of operands.

At block 504, the request execution tracking circuitry 208 determines a schedule for the formula execution, the schedule to include a first (e.g., starting) element (operand, vector, or indirection) to be accessed. For example, the request execution tracking circuitry 208 determines the order of operations for the formula. In some examples, the first element of the formula to be accessed is either an operand, a vector (e.g., array, matrix, etc.), or an indirection. An element is to be accessed from the corresponding physical memory address in order to begin execution of the formula. In some examples, the request execution tracking circuitry 208 the schedule to execute the formula identifies the order to access a set of operands of the formula.

At block 506, the computation circuitry 212 identifies memory address(es) of the elements, following an order set forth in the schedule. For example, the computation circuitry 212 uses the system address decoder circuitry 206 and/or the mapping table 218 to identify the physical memory address range of each element in the formula. In some examples, the computation circuitry 212 identifies memory address(es) of the set of operands in the formula. The computation circuitry 212 identifies the memory addresses in an order. For example, if the request execution tracking circuitry 208 determines that operand A is to be accessed first, then vector B[A−1] next, the computation circuitry 212 identifies the memory address of A first and the memory address of vector B[A−1] second.

At block 508, the coherency circuitry 214 addresses any coherency requirements associated with the memory address(es). For example, if the formula or the identified physical memory address ranges require coherency, the coherency circuitry 214 initiates a coherency protocol for that memory address range. Block 508 is described in further detail below in connection with FIG. 6.

At block 510, the peer memory controller 210 determines whether any elements of the formula are not hosted in local memory media. For example, the peer memory controller 210 obtains the physical memory addresses and determines whether any of them are located in a memory chiplet 114 different from the memory chiplet executing the formula. In some examples, the peer memory controller 210 uses the mapping table 218 to determine which memory chiplet 114 the physical memory address range is located.

When the peer memory controller 210 determines that one or more elements of the formula are not hosted in local memory media (e.g., block 510 returns a value YES), the peer memory controller 210 sends requests for respective elements to non-local memory media and requests for respective elements to local memory media (block 512). For example, the peer memory controller 210 determines, based on the formula data structure (e.g., formula table 216 of FIG. 2), that a second memory chiplet (114B, 114C, and/or 114D) stores data corresponding to the formula. The peer memory controller 210 sends memory access requests to one or more remote memory chiplets (e.g., to the second memory chiplet) based on at least one or of the elements (e.g., operands) are located (e.g., hosted) in a memory address of the remote memory chiplets (e.g., the second memory chiplet). The interconnect chiplet 116 communicates the request from the first memory chiplet to the second memory chiplet to obtain the data corresponding to the formula. The peer memory controller 210 additionally sends requests for data, if any, hosted in local physical memory addresses.

When the peer memory controller 210 determines that the elements of the formula are hosted in local memory media (e.g., block 510 returns a value NO), the peer memory controller 210 reads all elements of the formula from local memory media (block 514). For example, the peer memory controller 210 requests data from memory media of the memory chiplet 114 executing the formula, and does not have to send requests to remote memory chiplets 114A-D through the interconnect chiplet 116.

At block 516, the computation circuitry 212 computes the formula using the elements obtained from the memory requests. For example, the computation circuitry 212 computes the formula using the set of operands accessed from the first memory chiplet (114A) and second memory chiplet (114B, 114C, or 114D). The computation circuitry 212 performs any mathematical operations specified by the formula to complete the formula execution. In some examples, the computation circuitry 212 computes the formula in the order set forth in the schedule. For example, the computation circuitry 212 may wait to compute a second mathematical operation until a first operand is accessed.

At block 518, the in-memory compute circuitry 102 returns the result to the core 104. For example, the interface circuitry 202 may obtain the result of the execution from the computation circuitry 212 and return the result to the core 104 via HW API 118B. In some examples, the interface circuitry 202 returns the result to the memory controller 110. The result is returned in a manner set forth by the return type value. For example, the interface circuitry 202 may refer to the formula table 216 to determine wat the return type value is, and return the result as a memory read, a memory write, etc.

The operations 306 of FIG. 5 end when the in-memory compute circuitry 102 returns the result to the core 104. In some examples, the operations 306 may be repeated when a new request to execute a formula is received.

Turning to FIG. 6, a flowchart representative of example machine readable instructions and/or example operations 508 is illustrated that may be executed, instantiated, and/or performed by programmable circuitry to implement the coherency circuitry 214. The example machine-readable instructions and/or the example operations 508 of FIG. 6 begin at block 602, at which the computation circuitry 212 determines that an identified memory address range has a coherency requirement. For example, the computation circuitry 212 may determine, during decoding of the virtual memory address or during a search through the mapping table 218, that the physical memory address range for a particular element has a coherency requirement.

At block 604, the coherency circuitry 214 initiates a snoop filter to monitor the memory address being accessed. For example, the coherency circuitry 214 triggers the snoop filter to keep track of the reads from and writes to the physical memory address. The coherency circuitry 214 uses the snoop filter in order to take specific action in appropriate situations, such as updating all copies of the physical address range, restricting access to the physical address range, etc.

At block 606, the coherency circuitry 214 changes the state of the memory address line to “owned” when the formula is being executed. When a physical memory address line is described as “owned,” it means that a specific process or part of the in-memory compute circuitry 102 has exclusive access to that memory location at the moment, preventing other processes (other in-memory compute circuitry 102) from directly reading or writing data to that address without going through the proper memory management mechanisms. The coherency circuitry 214 changes the state of the memory address line in order to maintain required coherency through memory media of the computing environment 100 during formula execution.

At block 608, the coherency circuitry 214 blocks the “owned” line from being accessed by a different source, such as the core and remote memory controller. For example, the coherency circuitry 214 does not allow another entity, apart from the peer memory controller 210, to read, write, modify, and/or delete data in the owned physical memory address range.

At block 610, the coherency circuitry 214 causes the in-memory compute circuitry 102 currently executing the formula to be the “home” for the “owned” line. In the context of memory coherency, a “home” device refers to the specific processor or memory controller that is considered the primary source of truth for a particular memory address, responsible for managing cache/memory coherence and resolving conflicts when multiple processors try to access the same data. The “home” device is the “owner” of that memory location and coordinates updates across the system to maintain consistency across all caches and memory media in the computing environment 100.

When the coherency circuitry 214 causes the in-memory compute circuitry 102 currently executing the formula to be the “home” for the “owned” line, the coherency requirement is addressed. For example, the coherency protocol is initiated and the computation circuitry 212 can begin accessing data for formula execution. In some examples, the operations 600 may be repeated any time a new formula execution is requested that requires memory coherency.

FIGS. 7-10 illustrate further example systems that implement the in-memory compute circuitry 102 in accordance with teachings of this disclosure. FIG. 7 illustrates an example system 700 including an example compute device 702. The compute device 702 is a chiplet-based compute device and is illustrated as a package. The compute device 702 includes example compute chiplets 704, 706, an example communication chiplet 708, example memory chiplets 710-714, and an example network chiplet 716. The example compute chiplets 704, 706 include one or more processor cores, software stacks, memory controllers, etc., and/or any other components implemented to perform computation processing requested by an application. The example communication chiplet 708 is an input/output (I/O) hub that connects the compute chiplets 704, 706 with the memory chiplets 710-714 and the with devices external to the compute device 702. The memory chiplets 710-714 store data, including SpMM data and memory access formulas. The memory chiplets 710-714 may be implemented by dual in-line memory modules (DIMMs). The network chiplet 716 is the communication pathway between the memory chiplets 710-714. In some examples, the network chiplet 716 is implemented by a Universal Chiplet Interconnect Express (UCIe). In the example system 700, the memory chiplets 710-714 include the in-memory compute circuitry 102 to register and execute formulas provided by the compute chiplets 704 via the communication chiplet 708.

FIG. 8 illustrates an example system 800 including an example compute device 802. The compute device 802 includes example compute chiplets 804, 806, an example communication chiplet 808, example memory chiplets 810-814, and an example network chiplet 816. In the illustrated example, the in-memory compute circuitry 102 is integrated into the communication chiplet 808. The in-memory compute circuitry 102 communicates with the memory chiplets 810-814 to implement in-memory formula registration and execution for the compute device 802. For example, the in-memory compute circuitry 102 in the illustrated communicates with the memory chiplets 810-814 to register formulas at each memory chiplet 810-814 and to execute any formula computations.

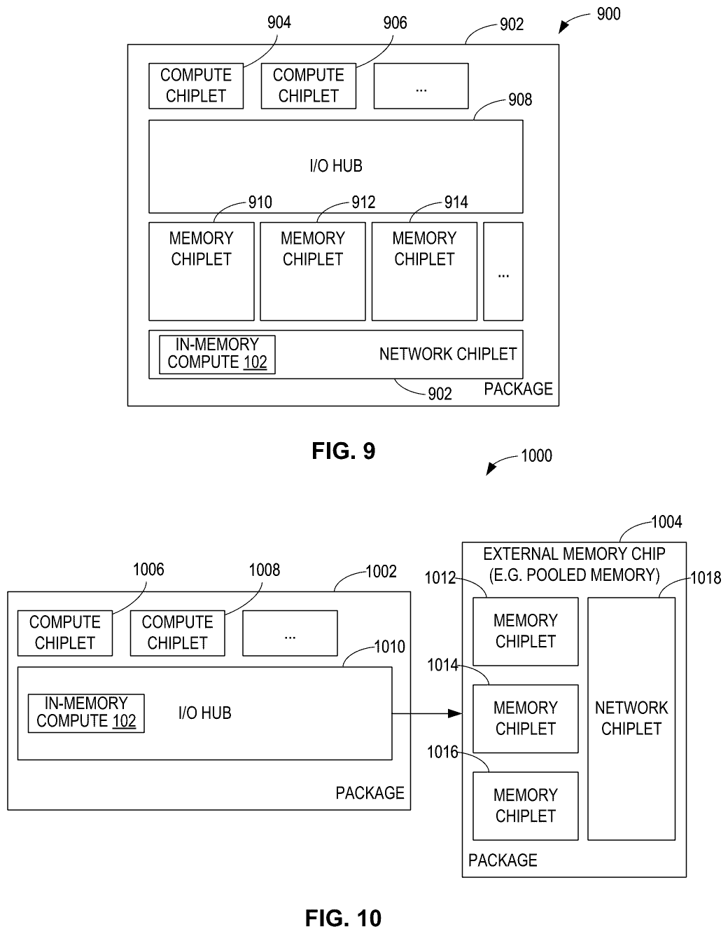

FIG. 9 illustrates an example system 900 including an example compute device 902. The compute device 902 includes example compute chiplets 904, 906, an example communication chiplet 908, example memory chiplets 910-914, and an example network chiplet 916. In the illustrated example, the in-memory compute circuitry 102 is integrated into the network chiplet 908. The in-memory compute circuitry 102 communicates with the memory chiplets 910-914 to implement in-memory formula registration and execution for the compute device 902. For example, the in-memory compute circuitry 102 in the illustrated communicates with the memory chiplets 910-914 to register formulas at each memory chiplet 910-914 and to execute any formula computations.

FIG. 10 illustrates an example system 1000 including an example compute device 1002 and an example compute device 1004. The compute device 1002 includes example compute chiplets 1006, 1008 and an example communication chiplet 1010. The compute device 1004 includes example memory chiplets 1012-1016 and an example network chiplet 1018. In the illustrated example, the in-memory compute circuitry 102 is integrated into the communication chiplet 1010. The communication chiplet 1010 communicates with example memory chiplets 1012-1016 of the compute device 1004 to implement in-memory formula registration and execution for the compute device 1004. In the illustrated example, the compute chiplet 1002 and the in-memory compute circuitry 102 is in communication with the compute device 1004 and memory chiplets 1012-1016 via the communication chiplet 1010.

FIG. 11 is a block diagram of an example programmable circuitry platform 1100 structured to execute and/or instantiate the example machine-readable instructions and/or the example operations of FIGS. 3-6 to implement the in-memory compute circuitry 102 of FIG. 2.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, chiplets, cores, FPGAs, microprocessors, CPUs, GPUs, VPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example formula configuration circuitry 204, the example system address decoder circuitry 206, the example request execution tracking circuitry 208, the example computation circuitry 212, and the example coherency circuitry 214.

The programmable circuitry 1112 of the illustrated example includes a local memory 1113 (e.g., a cache, hardware registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1111. In some examples, the memory controller 1117 may be implemented by one or more integrated circuits, logic circuits, microcontrollers from any desired family or manufacturer, or any other type of circuitry to manage the flow of data going to and from the main memory 1114, 1116. In FIG. 11, the memory controller 1117 implements the example peer memory controller 210.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In FIG. 11, the interface circuitry 1120 implements the example interface circuitry 202.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112.

One or more output devices 1124 are also connected to the interface circuitry 1120 of the illustrated example. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In FIG. 11, the mass storage device 1128 implements the example formula table 216 and the example mapping table 218.

The machine readable instructions 1132, which may be implemented by the machine readable instructions of FIGS. 3-6, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 3-6 to effectively instantiate the in-memory compute circuitry 102 of FIG. 2 as logic circuits to perform operations corresponding to those machine readable instructions. In some such examples, the in-memory compute circuitry 102 of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, a VPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 3-6.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of hardware registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The hardware registers 1218 are semiconductor-based structures to store data and/or instructions such as results of one or more of the operations performed by the AL circuitry 1216 of the corresponding core 1202. For example, the hardware registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The hardware registers 1218 may be arranged in a bank as shown in FIG. 12. Alternatively, the hardware registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 3-6 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-6. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-6. As such, the FPGA circuitry 1300 may be configured and/or structured to effectively instantiate some or all of the operations/functions corresponding to the machine readable instructions of the flowchart(s) of FIGS. 3-6 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 3-6 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 3-6 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), hardware registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by hardware registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 3-6 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 3-6, and/or an ASIC may be configured and/or structured to perform third operation(s)/function(s) corresponding to a third portion of the machine readable instructions represented by the flowcharts of FIGS. 3-6.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

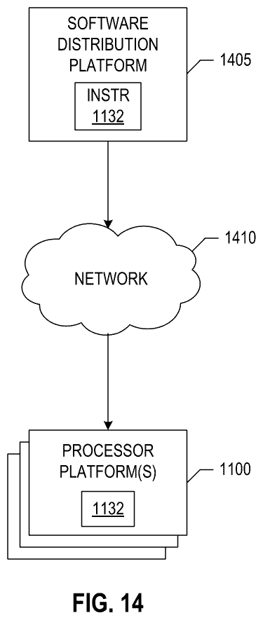

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 3-6, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 3-6, may be downloaded to the example programmable circuitry platform 1100, which is to execute the machine readable instructions 1132 to implement the in-memory compute circuitry 102. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

FIGS. 11, 15, 16A, and 16B include example computing architectures in which any of the techniques and configurations above may be implemented.

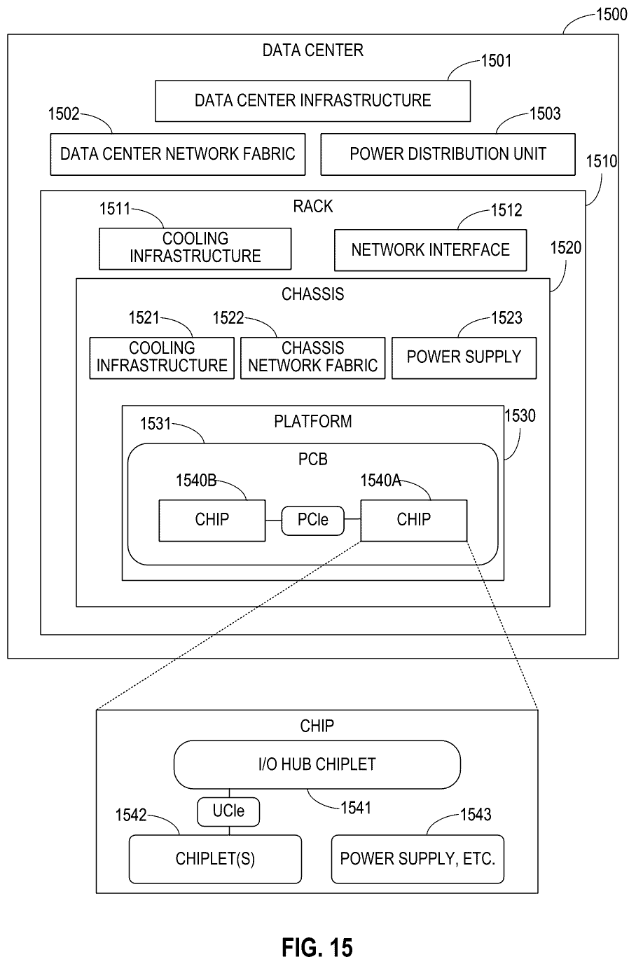

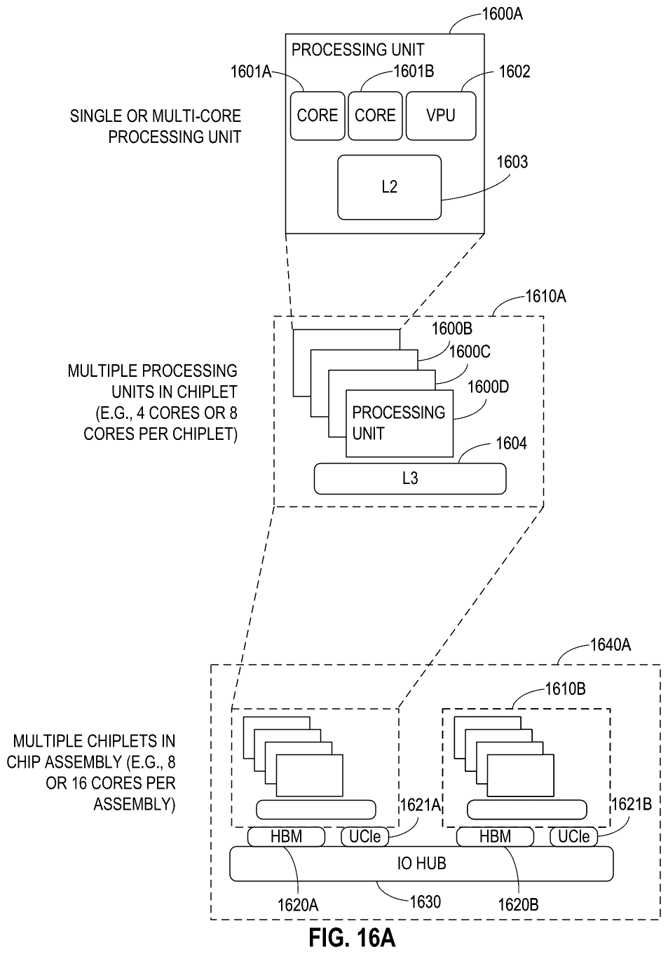

FIG. 15 illustrates an example hardware arrangement of an example data center 1500 used to provide multiple examples or instances of a computing system (e.g., the programmable circuitry platform 1100, described above), with each example of the computing system identified as a respective platform (e.g., the platform 1530, described below). The data center 1500 includes example data center infrastructure 1501, an example data center network fabric 1502, and an example power distribution unit 1503 to support multiple racks of compute platforms, with a single instance of an example rack 1510 depicted. The data center infrastructure 1501 may provide physical components that host the compute platform hardware, storage components, and/or networking equipment. The data center network fabric 1502 may include switches and/or networking components to support data flows among various compute platforms and storage devices throughout the data center. The power distribution unit 1503 may include components to distribute and/or control power among the various compute platforms, networking, and storage devices.

The rack 1510 of FIG. 15 includes, but is not limited to, example cooling infrastructure 1511, an example network interface 1512, and/or other related physical components to support discrete instances of multiple chassis. The rack 1510 provides power, connectivity, and/or cooling to each of the multiple chassis in a single rack, with a single instance of a chassis 1520 in the example of in FIG. 15. The chassis 1520 includes, but is not limited to, example cooling infrastructure 1521, an example chassis network fabric 1522, and an example power supply 1523, which provides cooling, network connectivity, and/or power to multiple platforms within the chassis. Although a single instance of an example platform 1530 is illustrated in FIG. 15, in some examples, a common data center rack configuration may include dozens of chassis, with each chassis to support a number of platforms depending on the physical size of the platform hardware and/or supporting equipment.

The platform 1530 of FIG. 15 may be referred to as a server or node, depending on the use case for the platform 1530 and the data center 1500. The platform 1530 includes but is not limited to examples of a discrete computing system hosted on a single board. In FIG. 15, the platform 1530 is illustrated as hosting a first example chip assembly 1540A and a second example chip assembly 1540B on a first board provided by a printed circuitry board (PCB) or other platform board, shown as an example PCB 1531. In some examples, the platform 1530 may include only one chip package, whereas the PCB 1531 includes interconnection of multiple chip assemblies via an interface (e.g., a peripheral component interconnect express (PCIe) interface). Additional chip packages and components may also be hosted on the PCB 1531.

Some examples of the chip assembly 1540A, 1540B of FIG. 15 may be termed as a System-on-Chip (SoC) package, as modular chiplets that perform different functions are integrated into a single package—even though this chip package is composed of multiple dies unlike a traditional SoC design that uses a single die. Other examples of the chip assembly 1540A, 1540B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 1540A and the second chip assembly 1540B of FIG. 15 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 1540A of FIG. 15 includes a I/O Hub chiplet 1541, chiplets 1542, and a power supply 1543. These components may be hosted on an interposer that is designed to connect multiple dies and/or components within a single semiconductor package (e.g., chip package). In some examples, the chiplets 1542 may be manufactured and/or sourced separately and later assembled into the chip package to create the chip assembly 1540A. Various connections may be provided among the chiplets 1542, such as with the use of Universal Chiplet Interconnect Express (UCIe) interfaces and communications, and/or between chiplets and on-chip memory (e.g., high-bandwidth memory (HBM)) using HBM 3 (JEDEC), Universal Memory Interface (UMI), or other memory interfaces.

FIG. 16A illustrates an example arrangement of an example chip assembly 1640A (e.g., a multi-processing core example of the first chip assembly 1540A or the second chip assembly 1540B of FIG. 15), with expanded views of the chiplets and processing units included herein. In FIG. 16A the chip assembly 1640A, which may constitute a SoC, SoP, SiP, and/or other type of chip package, includes chiplets such as an example chiplet 1610A, an example chiplet 1610B, etc. and associated on-package memory (e.g., high-speed memory) such as 3D-stacked, High Bandwidth Memory (HBM) instances (shown as an example HBM 1620A, an example HBM 1620B, interfaces (e.g., UCIe interfaces) shown as an example UCIe 1621A, an example UCIe 1621B, and an example I/O hub 1630 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency protocols), etc.

The chiplets 1610A, 1610B of FIG. 16A include multiple processing units and the example processing units 1600A, 1600B, 1600C, 1600D include one or multiple cores, respectively. For example, the chiplet 1610A of FIG. 16A includes four processing units (the processing units 1600A, 1600B, 1600C, 1600D) and an example Level 3 (L3) cache 1604. The processing units 1600A, 1600B, 1600C, 1600D may include one or multiple processing cores, one or multiple caches, other processing units and/or passive and/or active elements. For example, processing unit 1600A includes two cores (an example core 1601A and an example core 1601B), vector processing unit 1602, and an example level 2 (L2) cache 1603. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 16B is an example arrangement of an example chip assembly 1640B (e.g., a multi-chiplet high-performance computing (HPC) example of chip assembly 1540A, 1540B), adapted for HPC applications (e.g., parallel processing operations involving thousands, millions, or more of processors and/or cores operating simultaneously). The example chip assembly 1640B illustrates placement as a SiP, SoC, and/or other package onto a platform board (e.g., the PCB 1531 of FIG. 15). The platform board may be in a data center (e.g., the data center 1500 of FIG. 15) or in a standalone deployment setting (e.g., in a standalone computer system, mobile computing device, autonomous device, etc.).

The chip assembly 1640B of FIG. 16B is composed of multiple chiplets, shown with four chiplets, including example chiplets 1610C, 1610D, 1610E, 1610F. The chiplets 1610C, 1610D, 1610E, 1610F include multiple processing units, such as thirty two processing units with a corresponding level 3 (L3) cache for each processing unit. The processing units may include one or multiple cores, such as an example single-core processing unit 1600E shown as part of the chiplet 1610C. The chip assembly 1640B also includes corresponding memory resources, such as HBM elements corresponding to respective banks of processing units (e.g., HBM 1620B and HBM 1620C corresponding respective sets of processing units of chiplet 1610C), UCIe interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 1600, the chiplet 1610, the chip 1540, and/or the platform 1530 of FIGS. 15, 16A, and/or 16B) to perform operations described above for electronic systems or devices (e.g., to perform memory accesses and memory computing in memory, etc.). It should be further understood that software, including one or more machine readable instructions, that facilitate processing and operations as described above may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, chiplets that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that balance memory bandwidth and compute utilization in a computing environment by executing memory access computations at memory chiplets rather than at a processor core. By balancing memory bandwidth and compute utilization, example systems, apparatus, articles of manufacture, and methods improve the efficiency of using a computing device by ensuring that the processor can access data from memory quickly enough to keep up with computational power, and by preventing bottlenecks where the processor is waiting for data to be loaded, thereby improving the utilization of the computing environment's resources. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to execute memory access formulas in memory chiplets are disclosed herein. Further examples and combinations thereof include the following:

Example 1 includes a system comprising a plurality of memory chiplets including a first memory chiplet and a second memory chiplet, the first memory chiplet to register a formula with an identifier in a formula data structure, and determine, based on the formula data structure, that the second memory chiplet stores data corresponding to the formula, and interconnect chiplet circuitry connected to the plurality of memory chiplets, the interconnect chiplet circuitry to communicate a request from the first memory chiplet to the second memory chiplet to obtain the data corresponding to the formula.

Example 2 includes the system of example 1, wherein the plurality of memory chiplets include a third memory chiplet, the first memory chiplet to determine, based on the formula data structure, that the third memory chiplet stores data corresponding to the formula and the interconnect chiplet circuitry to communicate a second request from the first memory chiplet to the third memory chiplet to obtain data corresponding to the formula.

Example 3 includes the system of any one or more of the foregoing examples, wherein the first memory chiplet includes formula configuration circuitry to register the formula with the plurality of memory chiplets based on (1) the identifier, (2) parameters of the formula, and (3) memory addresses associated with the parameters in the formula.

Example 4 includes the system of example 3, wherein the formula configuration circuitry is to obtain the parameters of the formula from an operating system.

Example 5 includes the system of any one or more of the foregoing examples, wherein the second memory chiplet includes second formula configuration circuitry to register the formula with the identifier in a second formula data structure, and including a memory controller to select the first memory chiplet to execute the formula based on a first capacity of the first memory chiplet and a second capacity of the second memory chiplet.

Example 6 includes the system of any one or more of the foregoing examples, wherein the first memory chiplet includes system address decoder circuitry to determine, based on the formula data structure, that the second memory chiplet stores data corresponding to the formula, and request execution tracking circuitry to determine a schedule for executing the formula, the schedule to include first data of the formula to be accessed, wherein the system address decoder circuitry selects a memory address to identify based on the schedule.

Example 7 includes the system of any one or more of the foregoing examples, wherein the first memory chiplet includes at least one compute element to compute the formula using the data obtained from the first memory chiplet and the second memory chiplet.

Example 8 includes a first memory chiplet comprising interface circuitry to obtain an identifier and a set of operands in connection with a request to execute a formula, the formula associated with an order of operations registered in the first memory chiplet, computer readable instructions, and at least one processor circuit to be programmed based on the instructions to identify memory addresses of the set of operands, and send a memory access request to a second memory chiplet based on at least one of the operands in the set corresponding to data located in a memory address of the second memory chiplet, compute the formula using the set of operands accessed from the first memory chiplet and second memory chiplet, and return a result of the computed formula in response to the request.

Example 9 includes the first memory chiplet of example 8, wherein one or more of the at least one processor circuit is to register the formula with the first memory chiplet.

Example 10 includes the first memory chiplet of any one or more of the foregoing examples, wherein one or more of the at least one processor circuit is to populate a data structure of the first memory chiplet and a data structure of the second memory chiplet with registered formulas, the registered formulas including the identifier, the formula, and one or more operands.

Example 11 includes the first memory chiplet of any one or more of the foregoing examples, wherein the registered formulas are registered at the second memory chiplet.

Example 12 includes the first memory chiplet of any one or more of the foregoing examples, wherein the one or more of the at least one processor circuit is to use the data structure to identify the formula and determine one or more memory addresses storing the one or more operands.

Example 13 includes the first memory chiplet of any one or more of the foregoing examples, wherein the one or more of the at least one processor circuit is to enable coherency in response to a memory address being accessed having a coherency requirement, wherein the coherency is to control a state of the memory address during execution of the formula.

Example 14 includes the first memory chiplet of any one or more of the foregoing examples, wherein the one or more of the at least one processor circuit is to determine a schedule to execute the formula, the schedule to identify the order to access the set of operands.

Example 15 includes a non-transitory machine readable storage medium comprising instructions to cause at least one processor circuit of a first memory chiplet to at least obtain an identifier and a set of operands in connection with a request to execute a formula, the formula associated with an order of operations registered in the first memory chiplet, identify memory addresses of the set of operands, and send a memory access request to a second memory chiplet based on at least one of the operands in the set corresponding to data located in a memory address of the second memory chiplet, compute the formula using the set of operands accessed from the first memory chiplet and second memory chiplet, and return a result of the computed formula in response to the request.

Example 16 includes the non-transitory machine readable storage medium of example 15, wherein the instructions are to cause one or more of the at least one processor circuit to register the formula with the first memory chiplet.

Example 17 includes the non-transitory machine readable storage medium of any one or more of the foregoing examples, wherein the instructions are to cause one or more of the at least one processor circuit to populate a data structure of the first memory chiplet and a data structure of the second memory chiplet with registered formulas, the registered formulas including the identifier, the formula, and one or more operands.

Example 18 includes the non-transitory machine readable storage medium of any one or more of the foregoing examples, wherein the registered formulas are registered at the second memory chiplet.

Example 19 includes the non-transitory machine readable storage medium of any one or more of the foregoing examples, wherein the instructions are to cause one or more of the at least one processor circuit to use the data structure to identify the formula and determine one or more memory addresses storing the one or more operands.

Example 20 includes the non-transitory machine readable storage medium of any one or more of the foregoing examples, wherein the instructions are to cause one or more of the at least one processor circuit to enable coherency in response to a memory address being accessed having a coherency requirement, wherein the coherency is to control a state of the memory address during execution of the formula.

Example 21 includes the non-transitory machine readable storage medium of any one or more of the foregoing examples, wherein the instructions are to cause one or more of the at least one processor circuit to determine a schedule to execute the formula, the schedule to identify, based on the order of operations, an order to access the set of operands.

Example 22 includes a first memory chiplet comprising means for obtaining an identifier and a set of operands in connection with a request to execute a formula, the formula associated with an order of operations registered in the first memory chiplet, means for identifying memory addresses of the set of operands, and means for sending a memory access request to a second memory chiplet based on at least one of the operands in the set corresponding to data located in a memory address of the second memory chiplet, means for computing the formula using the set of operands accessed from the first memory chiplet and second memory chiplet, and means for returning a result of the computed formula in response to the request.

Example 23 includes the first memory chiplet of example 22, further including means for registering the formula with the first memory chiplet.

Example 24 includes the first memory chiplet of any one or more of the foregoing examples, wherein the means for registering the formula is to populate a data structure of the first memory chiplet and a data structure of the second memory chiplet with registered formulas, the registered formulas including the identifier, the formula, and one or more operands.

Example 25 includes the first memory chiplet of any one or more of the foregoing examples, wherein the registered formulas are registered at the second memory chiplet.

Example 26 includes the first memory chiplet of any one or more of the foregoing examples, wherein the means for identifying the memory addresses is to use the data structure to identify the formula and determine one or more memory addresses storing the one or more operands.

Example 27 includes the first memory chiplet of any one or more of the foregoing examples, further including means for enabling coherency in response to a memory address being accessed having a coherency requirement, wherein the coherency is to control a state of the memory address during execution of the formula.

Example 28 includes the first memory chiplet of any one or more of the foregoing examples, further including means for determining a schedule to execute the formula, the schedule to identify, based on the order of operations, an order to access the set of operands.

Example 29 includes a method comprising obtaining, at a first memory chiplet, an identifier and a set of operands in connection with a request to execute a formula, the formula associated with an order of operations registered in the first memory chiplet, identifying memory addresses of the set of operands, and sending a memory access request from the first memory chiplet to a second memory chiplet based on at least one of the operands in the set corresponding to data located in a memory address of the second memory chiplet, computing the formula, at the first memory chiplet, using the set of operands accessed from the first memory chiplet and second memory chiplet, and returning a result of the computed formula in response to the request.

Example 30 includes the method of example 29, further including registering the formula with the first memory chiplet.

Example 31 includes the method of example 29, further including populating a data structure of the first memory chiplet and a data structure of the second memory chiplet with registered formulas, the registered formulas including the identifier, the formula, and one or more operands.

Example 32 includes the method of any one or more of the foregoing examples, wherein the registered formulas are registered at the second memory chiplet.

Example 33 includes the method of any one or more of the foregoing examples, further including using the data structure to identify the formula and determine one or more memory addresses storing the one or more operands.

Example 34 includes the method of any one or more of the foregoing examples, further including enabling coherency in response to a memory address being accessed having a coherency requirement, wherein the coherency is to control a state of the memory address during execution of the formula.

Example 35 includes the method of any one or more of the foregoing examples, further including determining a schedule to execute the formula, the schedule to identify, based on the order of operations, an order to access the set of operands.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A system comprising:
a plurality of memory chiplets including a first memory chiplet and a second memory chiplet, the first memory chiplet to:
register a formula with an identifier in a formula data structure; and
determine, based on the formula data structure, that the second memory chiplet stores data corresponding to the formula; and
interconnect chiplet circuitry connected to the plurality of memory chiplets, the interconnect chiplet circuitry to communicate a request from the first memory chiplet to the second memory chiplet to obtain the data corresponding to the formula.

2. The system of claim 1, wherein the plurality of memory chiplets include a third memory chiplet, the interconnect chiplet circuitry to communicate a second request from the first memory chiplet to the third memory chiplet to obtain data corresponding to the formula.

3. The system of claim 1, wherein the first memory chiplet includes formula configuration circuitry to register the formula with the plurality of memory chiplets based on (1) the identifier, (2) parameters of the formula, and (3) memory addresses associated with the parameters in the formula.

4. The system of claim 3, wherein the formula configuration circuitry is to obtain the parameters of the formula from an operating system.

5. The system of claim 3, wherein the second memory chiplet includes second formula configuration circuitry to register the formula with the identifier in a second formula data structure, and including a memory controller to select the first memory chiplet to execute the formula based on a first capacity of the first memory chiplet and a second capacity of the second memory chiplet.

6. The system of claim 1, wherein the first memory chiplet includes:
system address decoder circuitry to determine, based on the formula data structure, that the second memory chiplet stores data corresponding to the formula; and
request execution tracking circuitry to determine a schedule for executing the formula, the schedule to include first data of the formula to be accessed, wherein the system address decoder circuitry selects a memory address to identify based on the schedule.

7. The system of claim 1, wherein the first memory chiplet includes at least one compute element to compute the formula using the data obtained from the first memory chiplet and the second memory chiplet.

8. A first memory chiplet comprising:
interface circuitry to obtain an identifier and a set of operands in connection with a request to execute a formula, the formula associated with an order of operations registered in the first memory chiplet;
computer readable instructions; and
at least one processor circuit to be programmed based on the instructions to:
identify memory addresses of the set of operands; and
send a memory access request to a second memory chiplet based on one of the operands in the set corresponding to data located in a memory address of the second memory chiplet;
compute the formula using the set of operands accessed from the first memory chiplet and second memory chiplet; and
return a result of the computed formula in response to the request.

9. The first memory chiplet of claim 8, wherein one or more of the at least one processor circuit is to register the formula.

10. The first memory chiplet of claim 8, wherein one or more of the at least one processor circuit is to populate a data structure of the first memory chiplet with registered formulas, the registered formulas including the identifier, the formula, and one or more operands.

11. The first memory chiplet of claim 10, wherein the registered formulas are registered at the second memory chiplet.

12. The first memory chiplet of claim 10, wherein the one or more of the at least one processor circuit is to use the data structure to identify the formula and determine one or more memory addresses storing the one or more operands.

13. The first memory chiplet of claim 8, wherein the one or more of the at least one processor circuit is to enable coherency in response to a memory address being accessed having a coherency requirement, wherein the coherency is to control a state of the memory address during execution of the formula.

14. The first memory chiplet of claim 8, wherein the one or more of the at least one processor circuit is to determine a schedule to execute the formula, the schedule to identify the order to access the set of operands.

15. A non-transitory machine readable storage medium comprising instructions to cause at least one processor circuit of a first memory chiplet to at least:
obtain an identifier and a set of operands in connection with a request to execute a formula, the formula associated with an order of operations registered in the first memory chiplet;
identify memory addresses of the set of operands; and
send a memory access request to a second memory chiplet based on one of the operands in the set corresponding to data located in a memory address of the second memory chiplet;
compute the formula using the set of operands accessed from the first memory chiplet and second memory chiplet; and
return a result of the computed formula in response to the request.

16. The non-transitory machine readable storage medium of claim 15, wherein the instructions are to cause one or more of the at least one processor circuit to register the formula with the first memory chiplet.

17. The non-transitory machine readable storage medium of claim 15, wherein the instructions are to cause one or more of the at least one processor circuit to populate a data structure of the first memory chiplet with registered formulas, the registered formulas including the identifier, the formula, and one or more operands.

18. The non-transitory machine readable storage medium of claim 17, wherein the registered formulas are registered at the second memory chiplet.

19. The non-transitory machine readable storage medium of claim 17, wherein the instructions are to cause one or more of the at least one processor circuit to use the data structure to identify the formula and determine one or more memory addresses storing the one or more operands.

20. The non-transitory machine readable storage medium of claim 15, wherein the instructions are to cause one or more of the at least one processor circuit to enable coherency in response to a memory address being accessed having a coherency requirement, wherein the coherency is to control a state of the memory address during execution of the formula.

21-35. (canceled)
